(19) United States
(12) Patent Application Publication
(10) Pub. No.: US 2002/0129086 A1
(43) Pub. Date: Sep. 12, 2002

(54) Cluster-based aggregated switching technique (CAST) for routing data packets and information objects in computer networks

(75) Inventors: J.J. Garcia-Luna-Aceves, San Mateo, CA (US); Arindam Samanta, Playa Del Rey, CA (US)

Correspondence Address: John P. O'Banion, O'BANION & RITCHEY LLP, Suite 1550, 400 Capitol Mall, Sacramento, CA, 95814, US

(73) Assignee: THE REGENTS OF THE UNIVERSITY OF CALIFORNIA

(21) Appl. No.: 09/945,104

(22) Filed: Aug. 31, 2001

Related U.S. Application Data
(60) Provisional application No. 60/229,646, filed on Aug. 31, 2000.

(51) Int. Cl. G06F 15/16

(52) U.S. Cl. 709/200

(57) ABSTRACT

A scalable packet forwarding approach to speed up unicast and multicast routing-table lookups in the Internet which we refer to as “Cluster-based Aggregation Switching Technique” or “CAST”. CAST integrates the use of two mechanisms: (i) organizing table entries into clusters and (ii) using cluster-label swapping so that packets can refer to specific clusters within which the routing-table lookup should take place. The motivation for introducing CAST is the escalating rate of improvement of Internet bandwidth available at backbone routers, which continues to exceed the maximum rate of packet processing power of high-speed routers. Simulations show that the hybrid approach used in CAST to expedite routing table lookups is more attractive for unicast routing than all prior approaches in terms of its lookup power and total memory size. Furthermore, CAST applies equally well to multicast routing, while many prior schemes do not.

### CROSS-REFERENCE TO RELATED APPLICATIONS

This application claims priority from U.S. provisional application serial No. 60/229,646 filed on Aug. 31, 2000, incorporated herein by reference.

### STATEMENT REGARDING FEDERALLY SPONSORED RESEARCH OR DEVELOPMENT

This invention was made with Government support under Grant No. F30602-97-0338, awarded by the Air Force Office of Scientific Research (AFOSR). The Government has certain rights in this invention.

### REFERENCE TO A COMPUTER PROGRAM APPENDIX

Not Applicable

### NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States Patent and Trademark Office file or records, but otherwise reserves all copyright rights whatsoever. The copyright owner does not hereby waive any of its rights to have this patent document maintained in secrecy, including without limitation its rights pursuant to 37 C.F.R. §1.14.

### BACKGROUND OF THE INVENTION

1. Field of the Invention

This invention pertains generally to routing data in the Internet, and more particularly to expediting unicast and multicast routing-table lookups by organizing routing-table entries into clusters, and by using pointers to such clusters in the data packets being switched.

2. Description of the Background Art

With the explosive growth in the number of networks reachable through the Internet, the routing table entries of Internet routers have to be aggregated to contain the time required to look up the next hop for a given Internet destination address. As a result, current routing tables in the backbone routers maintain entries consisting of a destination prefix, prefix length and next hop in their fields. Accordingly, given a destination address of a packet, a packet forwarding decision is made based on the longest-matching prefix. However, routers in high-speed backbones need to keep up with very high transmission speeds (e.g., 40 Gbps for OC-768 lines) and forwarding decisions at such backbone routers must be done at very high rates (e.g., 40 Million packets per second for an average packet size of 1000 bits).

Reducing the processing time required for packet forwarding is ultimately an end-to-end issue, which means that table lookup must be expedited at each router along the path from source to destination. However, because of the routing-table aggregation necessary to make routing tables be of manageable size, for a given packet being forwarded, the first router in the path has the least amount of lookup requirement, and the lookup time increases as the packet traverses its path towards the destination and reaches routers with smaller amounts of address aggregation. Accordingly, the lookup schemes should be the most efficient at routers in the backbone of the Internet and closer to the destinations, where either a large number of entries exist or aggregation is not as effective in reducing table lookup for the intended destination.

To be efficient, the table lookup mechanism used at each router should provide for a high packet-processing power, require as small an amount of memory as possible, and incur a small update time of the data structures after a routing update is received. Furthermore, as the Internet becomes more pervasive, as appliances and small devices are attached to it to implement virtual computers or sensor networks, and as more individuals and corporations start using the Internet for group communication, multicast routing-table lookup must be made as efficient as its unicast counterpart.

Accordingly, developing fast routing-table lookup techniques has become one of the hottest issues in routing research over the past few years, and the reason is simple: routing-table entries at backbone routers and line speeds in the Internet backbone continue to increase.

The routing-table lookup schemes proposed and implemented in the past can be categorized into three groups: non-cooperative lookup, cooperative lookup, and hybrid lookup. As FIG. 1 illustrates, in a non-cooperative lookup scheme a router performs lookups on its routing table independently of the other routers. By contrast, as FIG. 2 illustrates, in a cooperative lookup scheme a router performs its table lookups using information from other routers; in this case, the lookup carried out at a router to forward a given packet is completely determined by the information provided by the previous router in the header of the packet. Of course, a router can follow a hybrid approach for its table lookup, in which information provided in the packet being forwarded helps the forwarding router reduce the time incurred in looking up the next hop for the packet.

FIG. 3 compares table lookup schemes proposed in the past, in terms of the following parameters:

(a) Applicability of the Scheme, which indicates whether the lookup scheme applies to all routers in the path from source to destination, or only applies starting at the second hop of the path to the destination.

(b) Table Lookup Time needed to find the next hop of a data packet.

(c) Memory required to store the routing table.

(d) Update Time needed to correct the routing table when routing updates are received.

(e) Multicast Support, which indicates whether the scheme applies equally well to multicast packet forwarding. As the baseline for comparison of the lookup schemes, we assume a router with 45000 entries, which was the case of the Mae-East router in 1999. Based on this example, memory usages of less than 500 KBytes is considered low, more than 500 KBytes and less than 1500 KBytes is considered high, and more than 1500 KBytes is considered huge. Similarly, an update time of less than 30 memory accesses, more than 30 and less than 70 memory accesses, and more than 70 memory accesses, are considered low, high, and huge, respectively.

It is apparent from FIG. 3 that no prior scheme is applicable to all the routers of a path to a destination, has 0(l) complexity in lookup time, has low memory and update time, and applies to unicast and multicast routing.

Non-Cooperative Lookup

Non-cooperative lookup techniques are the most common among today's routers. A non-cooperative technique takes the destination address of the packet as an input as shown in FIG. 1 and finds the next hop of the packet as an output of searching. Non-cooperative lookup schemes are applicable to all the routers on the path of a packet. There are two major types of solutions within this category: solutions based on prefix trees and hardware-based solutions.

Prefix-Tree Solutions:

In this approach, all of the address prefixes are stored efficiently as a path compressed binary prefix tree called a Patricia trie. The Patricia trie scheme scales well in terms of the memory it requires, but its lookup time is high because each search for the best matching prefix takes a large number of memory accesses, given that the destination address is matched to a path in the trie by scanning each address bit. Accordingly, the Patricia trie scheme has a worst-case lookup time of 32 memory cycles for IPv4 addresses, which is not adequate for high-speed networks. Several enhancements advancements have been proposed to improve on the performance of Patricia ties, such as the LC trie, the DP trie, and the LPC trie. Note also that the Lulea scheme introduced a novel way of using prefix tree to achieve a higher packet processing power along with a very low memory requirement. On the minus side, the Lulea scheme has a high update time for a high volume of network updates; in the worst case, it shifts all the entries of the next hop routing table, which leads to a large number of memory accesses and slows down the lookup speed.

The packet processing power that can be obtained from prefix-tree solutions are not powerful enough for today's Internet backbone routers. For example, while schemes proposed by Waldvogel et al. and Srinivasan and Varghese decrease the lookup time by a binary search on the prefix length, they incur a high memory requirement and a high update time.

A key limitation of many prefix-tree approaches is that they are not directly applicable to multicast routing. In multicast routing table, aggregating two consecutive entries is almost impossible, because it is very unlikely that they share the same next hop links. Therefore, a multicast entry cannot be stored in the form of a prefix. Henceforth all prefix trie schemes like Patricia trie, DP trie and Lulea are not applicable to the multicast lookup. In contrast, the concept of level compression makes LPC trie schemes suitable for multicast. Similarly, the entries of the multicast routing table can be stored in form of an AVL tree. Other proposals for layer four switching are also applicable to multicast lookup.

Hardware Based Solutions:

In this approach, hardware is used to introduce parallelism and speed up routing-table lookup. The scheme by McAuley and Francis is an example of this approach, and is based on Content Addressable Memories (CAMs). CAM-based schemes are applicable to the multicast lookup, but are expensive. Another hardware-based approach consists of storing the routing table in main memory (DRAM). This technique is inexpensive and takes only one memory access to decide on next hop; however, the lookup performance is bounded by the high memory access time of main memory (DRAM). As an example, a current DRAM with 50 ns memory access time can only achieve a processing power of 20 MPPS. The limitation of this technique is the high update time. A third variant of this type of solutions consists of using complex hardware to achieve a large processing power of 32 MPPS; on the minus side, it is expensive. There are also other hardware-based solutions for multicast lookups, which are based on parallel lookups in the incoming and outgoing links.

Cooperative Lookup

As depicted in FIG. 2, the cooperative lookup technique is based on a fixed length field “index” (provided by the previous hop router of the packet) instead of destination IP address used in the non-cooperative lookup. This scheme achieves high performance by taking only a few memory accesses to obtain its best matching prefix. Cooperative lookup schemes are applicable to the second, third up to the last routers on the path of a packet. Among the most popular of this type of schemes are source hashing, Cisco's tag switching, Multiprotocol Label Switching Architecture (MPLS), Ipsilon's IP switching, Toshiba's CSR, and IBM's ARIS.

Note that in MPLS, a short fixed size index is assigned to a packet at the beginning. This index value is known as a “label” in MPLS. At subsequent hops, the label is used as an index to the routing table which specifies the next hop and a new label in turn. As the packet traverses the network the old label is replaced by a new label. In the same way, tag switching uses tag as the index and based on the tag it makes a decision on the next hop of the packet. A tag switch maintains two databases: a Forwarding Information Base (FIB) to store the normal routing table entries, and a Tag Information Base (TIB) to store the tags. Tag switching can be extended to multicast switching. As an example, a tag can be binded to the multicast group address in shared tree protocols. In the same way, all other cooperative lookup schemes are also applicable to the multicast lookup.

A limitation of these label-swapping schemes based on destination-tag binding is the duplication of packets in the presence of address aggregation. As an example, in FIG. 4 all the packets which match the entry <2,128/8-Link1,4> of router R1 are forwarded to the Link1 with 4 as an index. If the 128/8 prefix entry of the router R1 deaggregates into 128.0/9 and 128.128/9 in router R2, then all the packets with an index 4 match two entries of R2, and, therefore, misuse the vulnerable network bandwidth by generating duplicate packets. Cooperative lookup schemes also scale badly in their memory requirements, because they keep two sets of the routing table.

In IP Switching, every flow is cached in the ATM link-layer switch, which enables further traffic on the same IP flow to switch directly by ATM hardware. The main disadvantage of this scheme lies in its large memory requirement.

Hybrid Lookup

A router implementing a hybrid lookup scheme is partially dependent on the previous hop router of the packet in order to perform a lookup. Similarly it also performs a part of the lookup independently. For example, Bremler-Barr et al. developed a hybrid lookup scheme they call “routing with a clue,” and which we call “Clue” for short. In Clue, a trie is looked up distributedly by the routers along the path from source to destination, and this is achieved by data packets specifying, in effect, where the router ended its lookup. Hence, a Clue router starts its lookup where the previous router in the path has ended. The Clue scheme achieves high packet processing power but is not applicable to the router at the first hop of the path to the destination. Clue also has a very high memory requirement, because of high memory requirement of its hash table. This scheme is also dependent on the concept of prefix. However, since in a multicast lookup table an entry is not stored in the form of a prefix, the Clue scheme cannot be extended to multicast routing.

Therefore, there is a need for a routing method that is applicable to all the routers of a path to a destination, has O(1) complexity in lookup time, has low memory and update time, and applies to unicast and multicast routing. The present invention satisfies those needs, as well as others, and overcomes deficiencies in current routing techniques.

### BRIEF SUMMARY OF THE INVENTION

The present invention generally comprises a technique for expediting unicast and multicast routing-table lookups. This is achieved by organizing routing-table entries into clusters, and by using pointers to such clusters in the data packets being switched. Clusters are organized collaboratively according to various clustering methods. We call this technique “Cluster-based Aggregated Switching Technique” or “CAST”. Simulations have shown that the hybrid approach used in CAST to expedite routing table lookups is more attractive for unicast and multicast routing than all prior approaches in terms of its lookup power, total memory size and update time.

By way of example, and not of limitation, data is routed according to the invention by grouping routing-table entries into numbered clusters for lookup of a routing-table entry based on cluster number and destination address. Each routing-table entry is assigned a Cluster Number (Incoming) and a Cluster Number (Outgoing). Similarly, a data packet is assigned a Cluster Number (Incoming) for routing. When a data packet arrives at the router, the Cluster Number (Incoming) associated with the data packet is matched to a corresponding Cluster Number (Incoming) associated with the routing-table entries. Next, all of the routing-table entries associated with that cluster number are searched using the destination address associated with the data packet as an index. The arriving packet is then routed by selecting a routing-table entry corresponding to the destination address of the data packet. At that time, the Cluster Number (Incoming) of the data packet is replaced with the Cluster Number (Outgoing) associated with the corresponding routing-table entry.

An object of the invention is to provide for a routing method that is applicable to all the routers of a path to a destination.

Another object of the invention is to provide for a routing method that has O(1) complexity in lookup time.

Another object of the invention is to provide for a routing method that has low memory and update time.

Another object of the invention is to provide for a routing method that applies to unicast and multicast routing.

Further objects and advantages of the invention will be brought out in the following portions of the specification, wherein the detailed description is for the purpose of fully disclosing preferred embodiments of the invention without placing limitations thereon.

### BRIEF DESCRIPTION OF THE DRAWINGS

The invention will be more fully understood by reference to the following drawings which are for illustrative purposes only:

FIG. 1 is a diagram illustrating a non-cooperative lookup scheme in a router.

FIG. 2 is a diagram illustrating a cooperative lookup scheme in a router.

FIG. 3 is a chart comparing characteristics of various lookup schemes in routers.

FIG. 4 is a diagram illustrating duplication of packets in MPLS and tag switching.

FIG. 5 is a diagram showing a CAST packet according to the invention.

FIG. 6 is a diagram showing a network based view of CAST according to the invention.

FIG. 7 is a diagram illustrating CAST incoming and outgoing cluster numbering according to the present invention.

FIG. 8 is a diagram showing a router based view of CAST according to the invention.

FIG. 9 is a diagram showing prefix entry in a CAST router according to the invention.

FIG. 10A through FIG. 10C are diagrams showing conceptual differences between CAST, non-cooperative, and cooperative lookup schemes.

FIG. 11 is a chart comparing clustering schemes and applicability.

FIG. 12 is a chart showing a routing table of a CAST router “R”.

FIG. 13 is a chart showing a Patricia trie data structure of a router “R”.

FIG. 14 is a chart showing a Patricia clustering technique with a level 1 cutoff on a router “R”.

FIG. 15 is a chart showing a Patricia clustering technique with a level 2 cutoff on a router “R”.

FIG. 16 is a chart showing symmetric clustering at a router “R”.

FIG. 17 is a chart showing link clustering at a router “R”.

FIG. 18 is a chart illustrating aggregation in link clustering.

FIG. 19 is a chart lustrating support of high level address aggregation in CAST according to the invention.

FIG. 20A through FIG. 20C are data structures, tables and algorithms showing an implementation of CAST with symmetric and Patricia clustering according to the invention.

FIG. 21A through FIG. 21C are data structures, tables and algorithms showing an implementation of CAST with link clustering according to the invention.

FIG. 22 shows multicast routing tables for routers “A” and “B”.

FIG. 23 shows multicast AVL tries for routers “A” and “B”.

FIG. 24 shows multicast routing tables for routers “A” and “B” after clustering.

FIG. 25 is a chart showing assignments of cluster numbers for router “A”.

FIG. 26 is a diagram depicting CAST in a multicast network according to the invention.

FIG. 27 is a diagram illustrating aggregation in multicast CAST for router “A” according to the invention.

FIG. 28 is a diagram illustrating Patricia trie non-cooperative lookup.

FIG. 29 is a diagram illustrating lookup for CAST with Patricia clustering according to the invention.

FIG. 30 is a diagram illustrating CAST with a “best possible clustering” technique according to the invention.

FIG. 31 graph showing an analytical description of lookup time in CAST for n=65635.

FIG. 32 is a graph showing an analytical description of additional memory requirements in CAST.

FIG. 33 is a graph showing a CAST curve for the MAE-EAST router.

FIG. 34 is a graph showing a CAST curve for the MAE-WEST router.

FIG. 35 is a graph showing a CAST curve for the PAC-BELL router.

FIG. 36 is a graph showing a CAST curve for the MDS router.

FIG. 37 is a graph showing a CAST curve for the PAIX router.

FIG. 38 is a chart showing actual implementation results for various routing methods.

FIG. 39 is a chart showing multicast simulation results for CAST where the number of outgoing links is ten.

FIG. 40 is a graph showing aggregation vs. number entries for CAST aggregation and normal aggregation in a multicast routing table where the number of outgoing links is three.

FIG. 41 is a graph showing aggregation vs. number of outgoing links for CAST aggregation and normal aggregation in a multicast routing table where the number of entries is 2500.

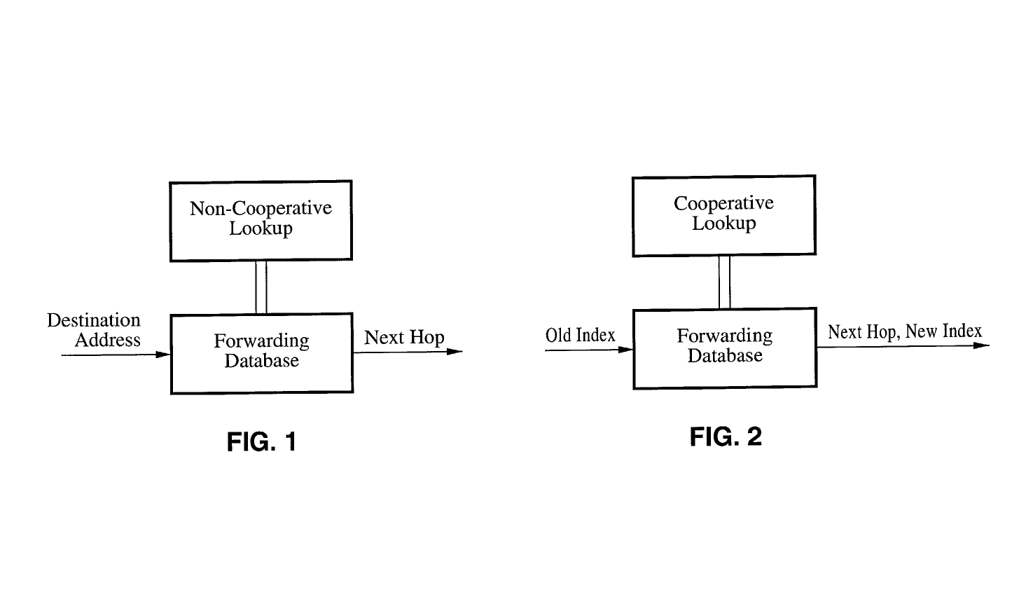

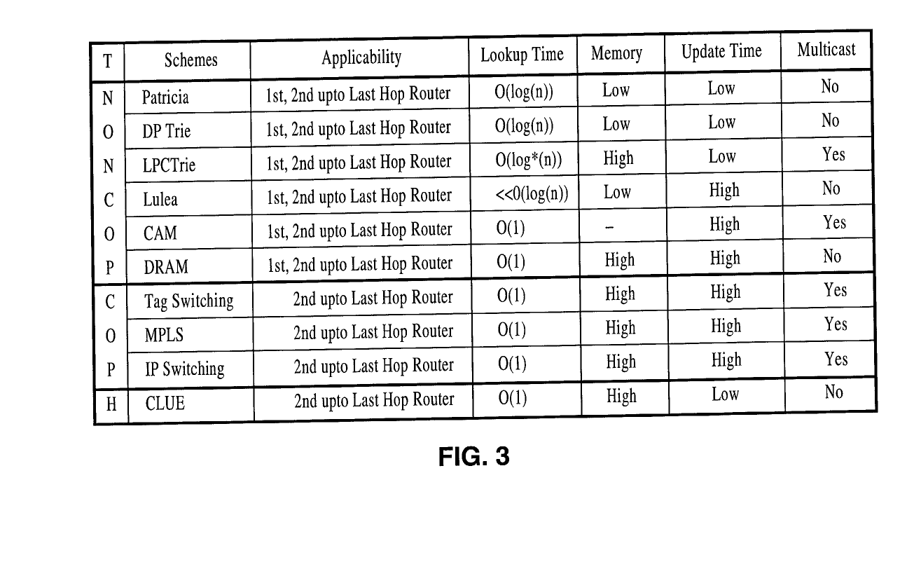

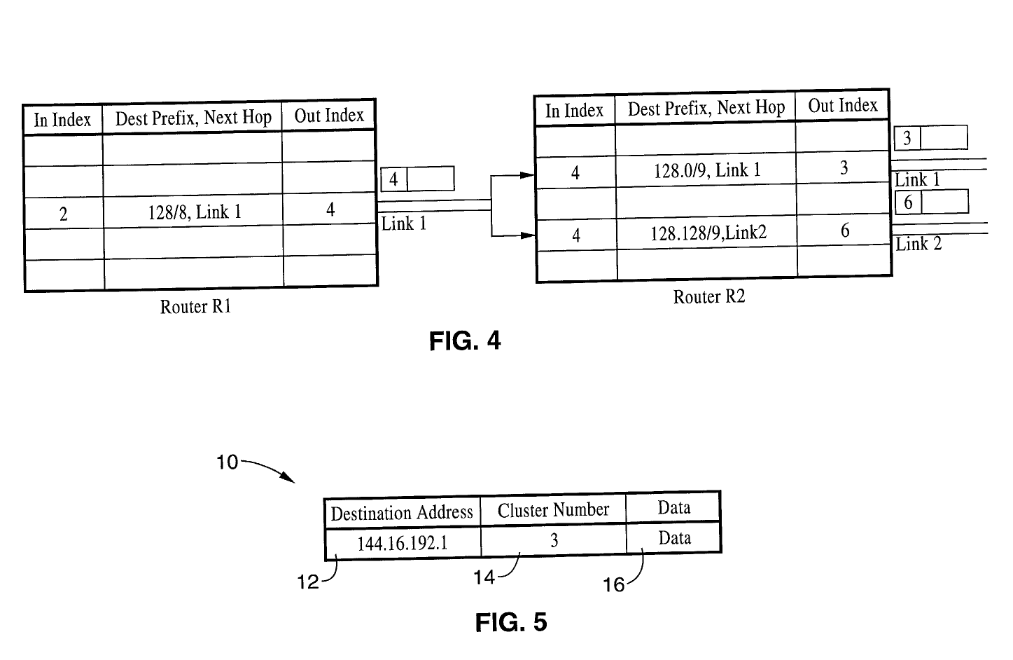

### DETAILED DESCRIPTION OF THE INVENTION

The present invention, which is referred to herein as “Cluster-based Aggregated Switching Technique” or “CAST”, is a method for expediting unicast and multicast routing-table lookups by organizing routing-table entries into clusters, and by using pointers to such clusters in the data packets being switched. Clusters are organized collaboratively according to various clustering methods.

As used herein, the term “data packets” is intended to encompass “information objects” and vice versa, and use of one term is not intended to exclude the other. Additionally, the terms “routing” and “switching” are use synonymously.

1. Description of CAST

CAST is a hybrid lookup method that achieves high packet processing power less expensively than other techniques, and with low memory requirements as well as low update time. CAST also supports high degree of prefix aggregation. Another advantage of CAST is its applicability to all hop routers on the path. This scheme is applicable to both unicast and multicast traffic. Furthermore, parameters of CAST can be scaled to suit it best in a particular routing environment.

A non-cooperative lookup technique uses the destination address of the packet to obtain a best matching prefix. In the cooperative lookup technique, a packet comes with an index and the lookup is performed on the basis of that index. In contrast, CAST is a hybrid lookup scheme in which the lookup depends on both destination address and an index called cluster number.

FIG. 5 shows the three fields of a CAST packet 10: destination address 12, cluster number 14 and data 16. A CAST router uses both destination address and the cluster number to perform a lookup. As a router makes a decision on the next hop, it replaces the old cluster number by a new cluster number and forwards the packet to the next hop router towards the destination.

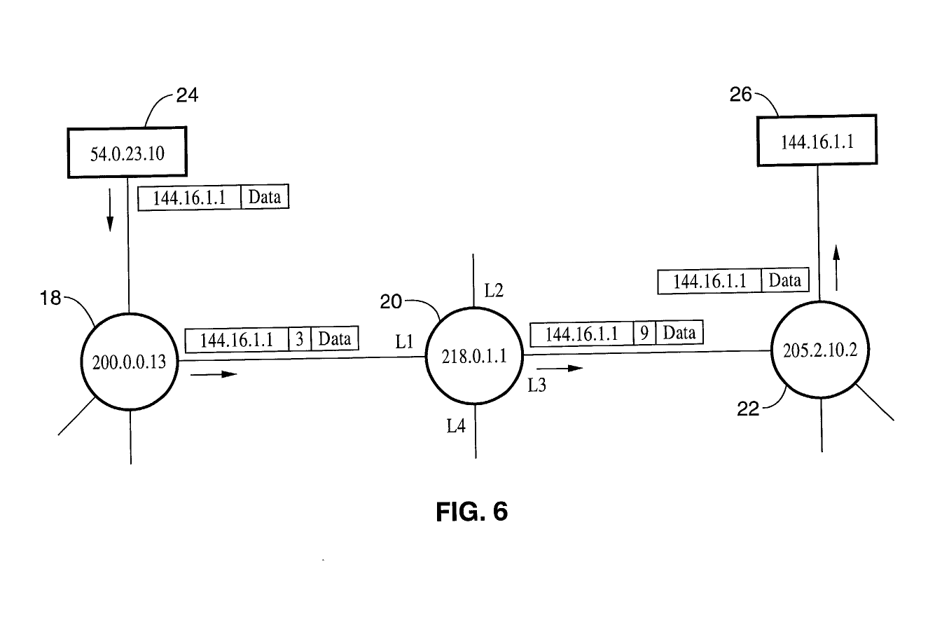

Referring to FIG. 6, to describe the behavior of CAST in a network, we take a network model containing three routers 18, 20, 22 and two hosts 24, 26 where all three routers are CAST routers. Any packet sent by the host “54.0.23.10” and destined for “144.16.1.1” comes across three CAST routers in FIG. 6 and finally reaches its destination. A host in the network does not store the clusters, unlike a router, because a host does not have all the properties of a router. Thus the packet reaches the first hop router “200.0.0.13” without a cluster number and the router “200.0.0.13” performs a CAST lookup based on only the destination address “144.16.1.1” of the packet. It should be noted that a CAST lookup at the first hop router of the path is different from a normal lookup because CAST scheme is applicable to all hop routers on the path of a packet. So a CAST router can perform a CAST lookup even without a cluster number.

After a CAST lookup, router “200.0.0.13” adds a cluster number “3” to the packet and forwards it to the next hop router. In turn, router “218.0.1.1” receives the packet and performs a CAST lookup by using both destination address and the cluster number and then replaces the old cluster number “3” by a new cluster number “9” before forwarding it to the next hop. This process goes on until the packet reaches the last hop router “205.2.10.2”.

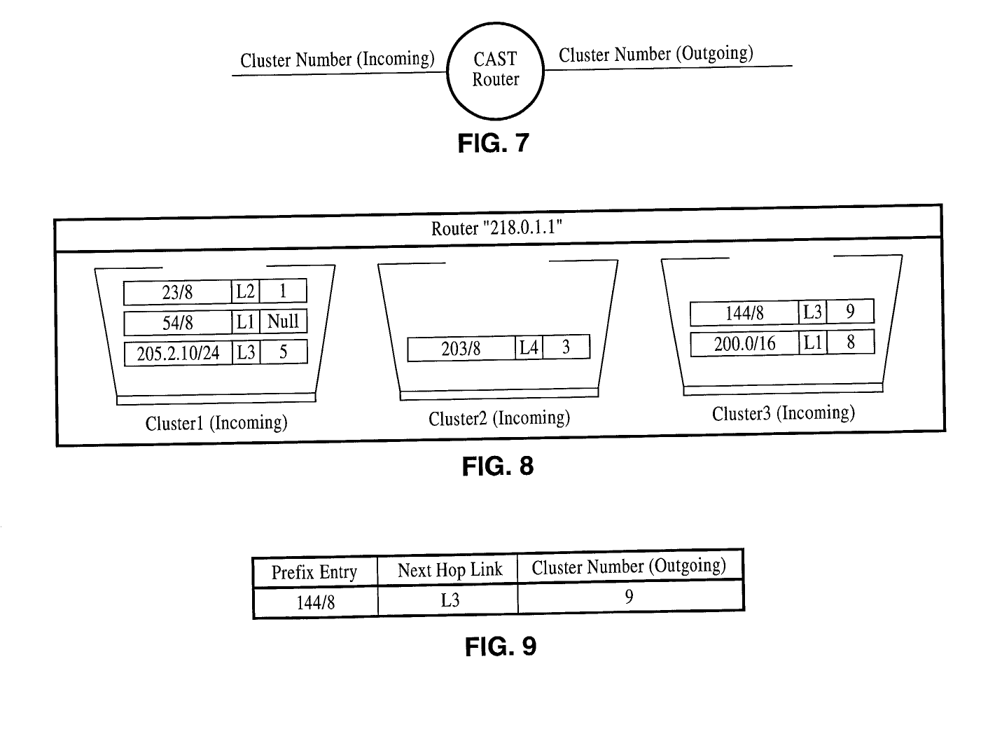

Referring to FIG. 7, for sake of simplicity the old cluster number that comes along with a packet and reaches a router is called incoming cluster number or the “Cluster Number (Incoming)”. Similarly, the new cluster number which is replaced by the router and forwarded with the packet to the next hop router is called outgoing cluster number or the “Cluster Number (Outgoing)”.

FIG. 8 describes the router based view of CAST in the network model of FIG. 6. In a CAST router, all of the routing table entries are divided into small groups. Each group is called a cluster and a Cluster Number (Incoming) is assigned to each cluster. Upon arrival, a packet jumps to a particular cluster depending upon its Cluster Number (Incoming). Thereafter the packet searches all the entries in that cluster by using its destination address as an index and finally gets its best matching prefix.

A normal routing table entry contains two fields: a prefix, a next hop link. As shown in FIG. 9, however, in CAST an extra field called Cluster Number (Outgoing) is added to each entry. Henceforth, after obtaining the best matching prefix, the old Cluster Number (Incoming) is replaced by the new Cluster Number (Outgoing) which is obtained from the matched entry.

In the example shown in FIG. 6 and FIG. 8, the router “218.0.1.1” contains six aggregated prefix entries in its routing table and all its six entries are divided into three clusters (incoming). Cluster numbers (incoming) “1”, “2”, and “3” are assigned to three clusters accordingly. Henceforth the packet with a cluster number “3” (incoming) directly jumps to cluster “3” and searches all three entries in that particular cluster by using its destination address “144.16.1.1” as an index. Finally, the packet gets “144/8” as its best matching prefix and it is forwarded to the next hop link L3 along with a new cluster number “9” (outgoing) obtained from the matched entry.

A router communicates its Cluster Numbers (Incoming) to all its neighbors along with the normal routing updates. Thus in FIG. 6, along with a normal routing update router “218.0.1.1” informs router “200.0.0.13” that it has assigned Cluster Number (Incoming) “3” for the entry “144/8”. If a previous hop router does not get to know about Cluster Number (Outgoing) for a particular prefix entry it marks the Cluster Number (Outgoing) field of that entry as “Null”. In FIG. 8 cluster “1” (incoming) contains an entry with a “Null” Cluster Number (Outgoing). Upon receiving a packet with a “Null” Cluster Number (Incoming), a CAST router performs a CAST lookup which is similar to the lookup performed at the first hop router of the packet.

1.1 Conceptual Differences Between CAST and Other Schemes

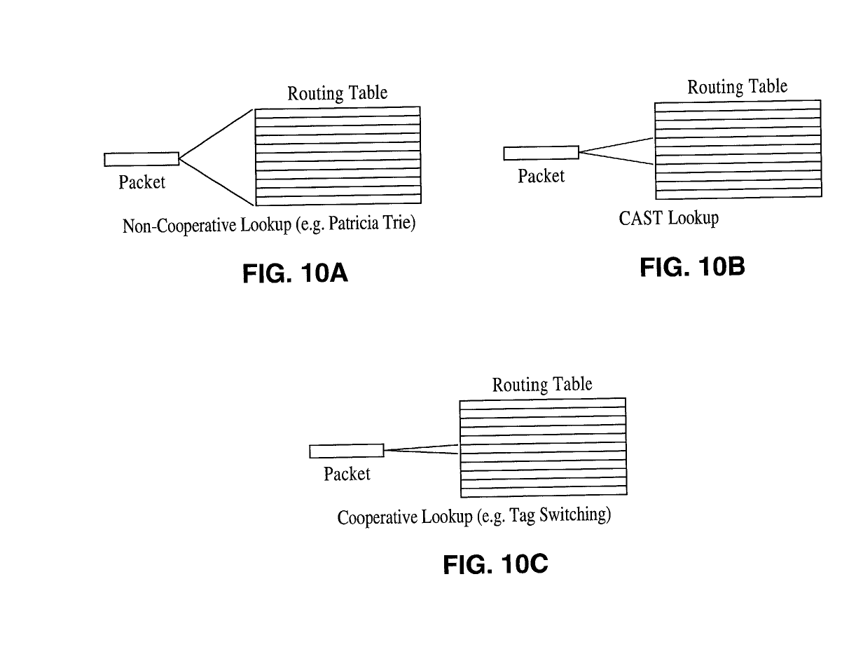

FIG. 10A through FIG. 10C highlight the differences between CAST (FIG. 10B), non-cooperative (FIG. 10A) and cooperative lookup schemes (FIG. 10C). In non-cooperative lookup, a packet searches all the entries of a routing table (FIG. 10A). Thus it can be said that a packet in non-cooperative lookup comes with a virtual pointer pointing to all rows (all prefix entries) of the routing table. In cooperative lookup (e.g. source hashing, tag switching) a packet comes with an index which points to a single row (a single prefix entry) of the routing table (FIG. 10C). In CAST, however, the index or Cluster Number (Incoming) of a packet points to multiple rows (multiple entries) of the routing table (FIG. 10B). Thus CAST can be scaled according to the need in a particular routing environment by varying the number of rows that the packet index points to. It can also be said that CAST is more generalized approach of non-cooperative and cooperative lookup.

The concept behind CAST also differs from that of Clue. In Clue, each router adds a clue to each packet informing the next hop router that where it has ended the lookup. The main difference between two schemes is Clue assumes that the routing table of two neighbors on the path of a packet are similar and follow the same lookup scheme. Thus, if two neighbors on the path follow the different lookup schemes, the clue added by a previous hop router might not be beneficial to the next hop router. In contrast, CAST is applicable to two neighbors on the path performing different lookup schemes because the Cluster Numbers (Incoming) are communicated between two routers. Therefore, the cluster number added by a previous hop router of the packet is always beneficial to the next hop router.

Other differences between CAST and Clue lie in intercommunication between routers and applicability in multicast lookup. In Clue there is no communication between two routers. In contrast, a CAST router performs a pure distributed lookup by communicating the Cluster Numbers (Incoming) to its neighbors. Additionally, Clue based on prefix is not applicable to the multicast as the multicast prefix entries are not stored in form of prefix tree unlike unicast. On the other hand, CAST can also be extended to multicast.

1.2 CAST as Hybrid Lookup

Upon receiving a packet, a CAST router reads the Cluster Number (Incoming) from the packet and directly goes to that cluster (incoming). Thereafter it uses the destination address of the packet to search all the entries of that cluster (incoming). Henceforth a CAST router is partially dependent on the previous hop router of the packet to obtain the Cluster Number (Incoming). In same way, it is partially independent for completing the lookup by using the destination address of the packet. For this reason CAST is called a hybrid lookup scheme.

1.3 Clustering

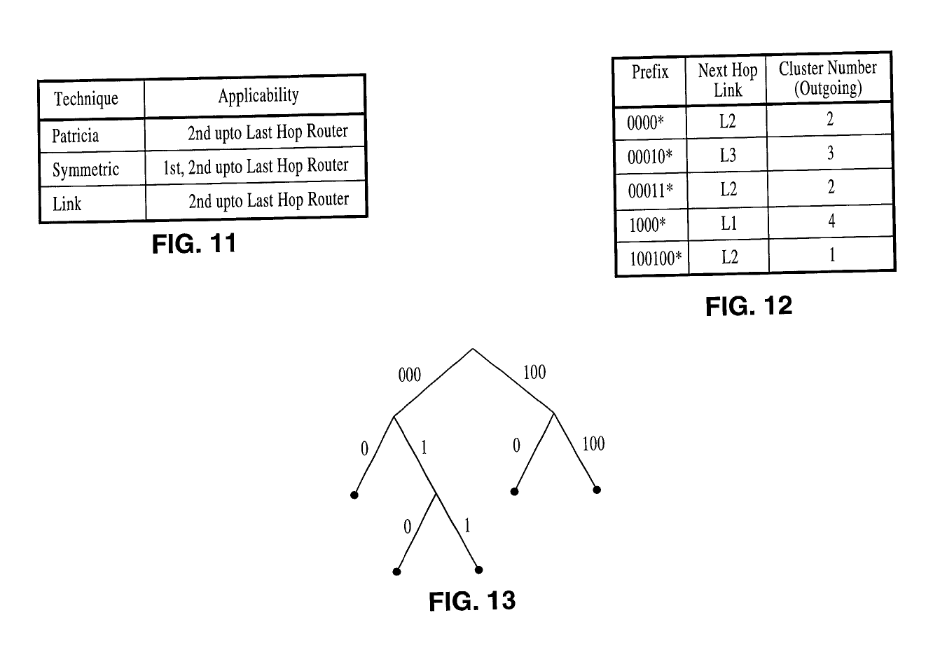

The creation of clusters from a routing table consisting of many entries is at the heart of CAST. Clustering is the process of creating clusters by grouping the entries together, and is performed on the basis on some properties and in a way such that all prefix entries of a particular cluster maintains the same property. The next subsections describe three clustering techniques: Patricia clustering; symmetric clustering; and link clustering technique. As can be seen from FIG. 11, Patricia clustering and link clustering are not applicable to the first-hop routers. On the other hand, symmetric clustering is applicable to all hop routers on the path as shown in FIG. 11. Referring also to FIG. 12, the clustering techniques are described with the help of an example routing table of a CAST router “R” containing five prefix entries.

1.3.1 Patricia Clustering

Patricia clustering is designed by keeping a view of current network scenarios in mind. In today's network it does not make sense to expect every packet to come with a valid cluster number as the simultaneous deployment of CAST in every router is almost impossible. Hence, a packet might come from a Non-CAST router without a cluster number and, to achieve high performance for these type of packets, Patricia trie data structure should be maintained.

In Patricia clustering, clustering is performed on the Patricia trie without destroying its data structure. Patricia clustering with “Level n Cutoff” is defined in a way such that each node in the Patricia trie which sits at the level between and including 0-th level to (n−1 )-th level forms a cluster with only itself included in that cluster and each n-th level node forms a cluster with itself and all its descendent nodes included in the cluster form by it. The root of a Patricia trie is considered to be sitting at the 0-th level. It should be carefully noted that each node in a Patricia trie does not always represent a prefix entry. Thus in a “Level n Cutoff”, each node at the level between and including 0-th level to (n−1)-th level forms a cluster with at most one prefix entry in it and a cluster might exist without having a prefix entry in it. Similarly, each n-th level node forms a cluster with at least one prefix entry therein.

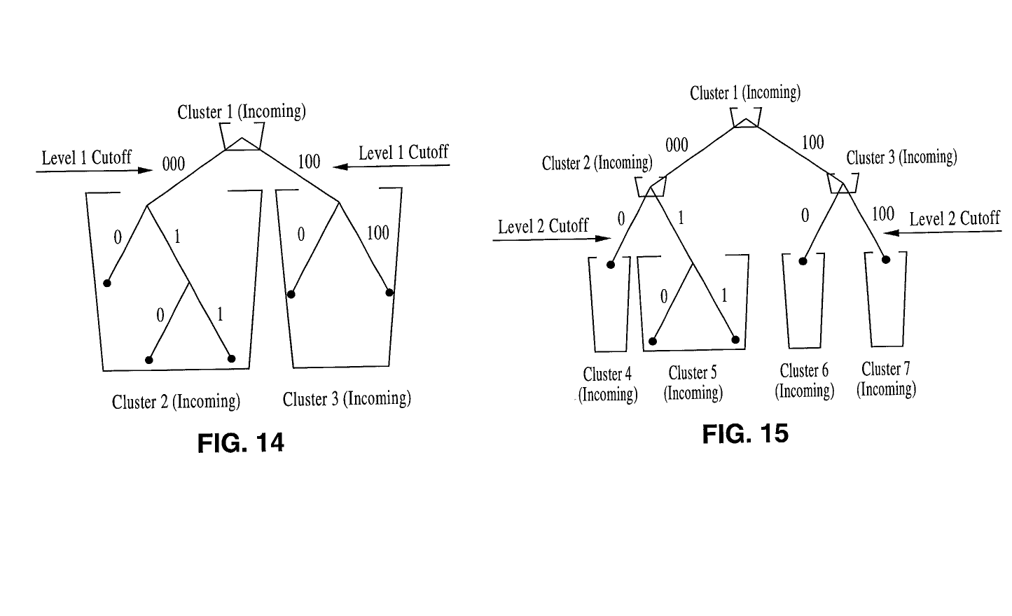

FIG. 13 shows an example of the Patricia trie of the Router “R”. By performing Patricia clustering with a level “1” cutoff, three clusters are formed in the router “R” as shown in FIG. 14. By numbering them accordingly it can be seen that cluster “1” does not contain any prefix entry, and cluster “2” and cluster “3” each contains three prefix entries.

From a CAST viewpoint of Patricia clustering, upon arrival of a packet with cluster number “3” the router “R” begins lookup from the root node of cluster “3”. More specifically the lookup begins at level “1” unlike the normal trie lookup scheme which begins at level “0”. This shows that a packet with the cluster number “3” (incoming) gains one memory access in “CAST with Patricia clustering of level ‘1’ cutoff” lookup, over the normal Patricia trie lookup scheme.

A packet which arrives along with a “Null” Cluster Number (Incoming) begins 1 lookup at the level “0” which is the root of the trie and performs a normal routing lookup by searching all the entries. For example, FIG. 15 shows Patricia clustering with a level “2” cutoff at the router “R” which forms seven clusters. With the same reasoning as above, in “CAST with Patricia clustering of level ‘2’ cutoff” lookup, all packets with cluster numbers (incoming) “4”, “5”, “6”, and “7” gain two memory accesses over the normal Patricia trie lookup scheme. Similarly all packets with Cluster Numbers (Incoming) “2” and “3” have a gain of one memory access. This speeds up the lookup time.

Normal Patricia trie lookup is a “CAST lookup with Patricia clustering of level ‘0’ cutoff”. Because “Patricia clustering with a level ‘0’ cutoff” forms only one cluster (incoming) with the root node of the cluster matching with that of the Patricia trie.

1.3.2 Symmetric Clustering

Symmetric clustering is applicable to all hop routers on the path of a packet towards its destination. It can be applied to the first hop router where a packet reaches without a cluster number. Similarly it can also be extended to second and successive hop routers where a packet might reach with a “Null” Cluster Number (Incoming). A packet always reaches a router along with a destination address. Symmetric clustering scheme shows how a packet can jump to different clusters depending on its destination address.

In a normal Patricia trie, lookup begins at the root of the trie. Then, depending on the first bit of the destination address, it jumps either to the left or to the right child. If the top n bits (not level) of the Patricia trie do not contain any prefix entry, instead of jumping to the root a packet can directly jump to the level at the n-th bit position depending on the first n bits of its destination address. In terms of cluster, if the first n bits of the Patricia trie do not contain any prefix entry, in symmetric clustering a packet jumps to twenty-one clusters (incoming) (maximum possible nodes at the n-th bit level of a trie) depending on the first n bits of the destination address. By directly jumping to the n-th bit level of the trie a packet gains n memory accesses over the normal routing lookup schemes. This expedites the lookup time at the first hop router and also at the second and successive hop routers receiving the packets with “Null” Cluster Numbers (Incoming).

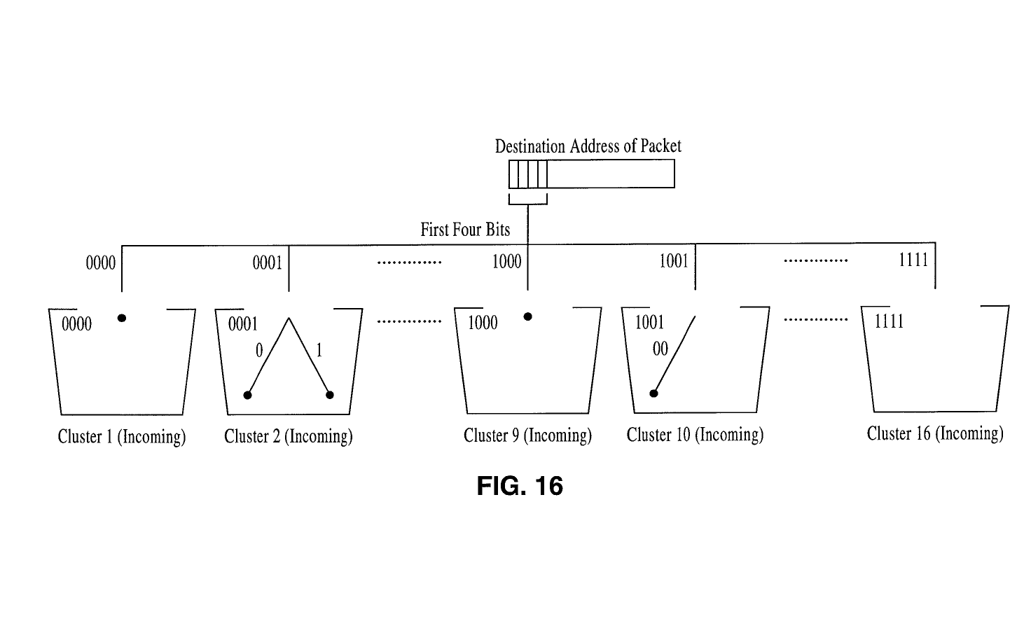

FIG. 16 illustrates symmetric clustering at the router “R” with the help of the routing table and Patricia trie shown in FIG. 12 and FIG. 13. Here, the top four bits (two levels) of the Patricia trie of the router “R” do not contain any prefix entry. Henceforth, the first four bits of the destination address of the packet are used to form and address 24 or 16 clusters (FIG. 16). Upon arrival of a packet at a first hop CAST router along with 0001 as its first four bits, a jumping to the cluster “2” takes place which is similar to a direct jumping to the level “2” in the Patricia trie lookup (FIG. 13). This expedites the lookup time by two memory accesses over Patricia trie lookup. Similarly, if a packet arrives at the second or the successive hop CAST routers along with 1001 as its first four bits, it jumps to the root node of cluster 1001 which is obtained by a decompression of the path 100100.

This clustering scheme is called symmetric because the lookup starts from the n-th bit position in every direction of branching in the trie regardless of the path compression. Accordingly, if a path compression occurs at n-th bit level of the trie, the path is decompressed with an extraction of n bits starting from the root.

1.3.3 Link Clustering

Link clustering is designed for the future networks where it might be possible to deploy CAST on every router and it can be expected that each packet comes with a cluster number. “CAST with link clustering” compresses the routing table with a further level of aggregation over normal aggregation in a router. In a normal routing table, all the entries are stored in form of (prefix, next hop), where the prefix field is used to index the routing table. However, in link clustering, routing table entries are stored in reverse order and in form of (next hop, prefix) where the routing table is indexed by next hop field. In terms of clustering, the routing table is clusterized in link clustering on the basis of next hop field. Thus all the entries share the same next hop link are grouped together into a cluster.

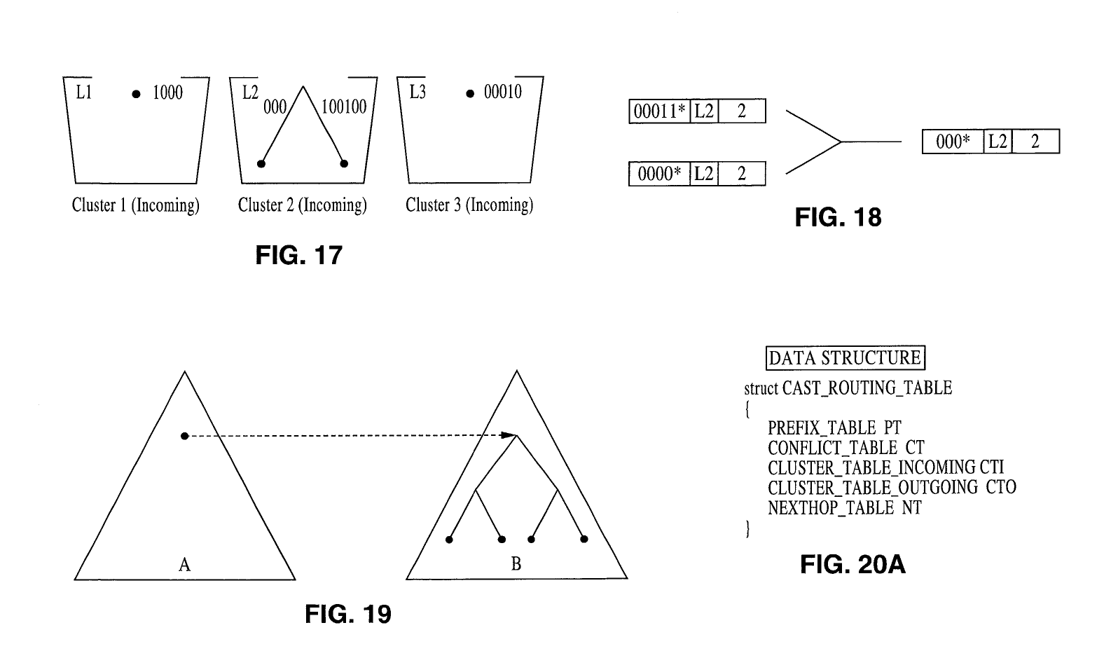

FIG. 17 shows the clusters formed by link clustering at the router “R” (FIG. 12) where there are three next hop links L1, L2, L3. Cluster “1” (incoming) and cluster “3” (incoming) are formed with one entry each. Similarly, three entries of router “R” sharing L2 as their next hop link are grouped together in cluster “3” (incoming). More interestingly, cluster “2” (incoming) achieves a further level of aggregation. FIG. 18 shows how the prefixes 00011* and 0000* which have common Cluster Number (Outgoing) “2” are aggregated into a single prefix entry 000*.

1.4 Implementing CAST in Routers

In CAST, the Cluster Numbers (Incoming) are communicated to the previous hop routers along with the routing updates. Thus, whenever an entry is added to the router, a Cluster Number (Incoming) and a Cluster Number (Outgoing) are assigned to the entry and the Cluster Number (Incoming) is communicated to a the neighbors along with a routing update.

“CAST with Patricia clustering” supports high level of address aggregation. In case of an aggregation at the previous hop router, previous hop router stores the Cluster Number (Incoming) of the aggregated prefix at the next hop router. FIG. 19 shows an example where a high level of address aggregation takes place in router “A” with a level two aggregation of four entries of router “B”. A packet that matches the aggregated entry of router “A” jumps to the root node of all four prefixes entries as an entry point of a cluster and thereafter it begins lookup at router “B”. In case of deaggregation or any other conflict, the previous hop router stores “NULL” in the Cluster Number (Outgoing) field.

In CAST, each packet comes with a Cluster Number (Incoming). Therefore, an additional field cluster number is defined in each CAST packet format. An extension header in either IPv4 or IPv6 can be used to define this additional field.

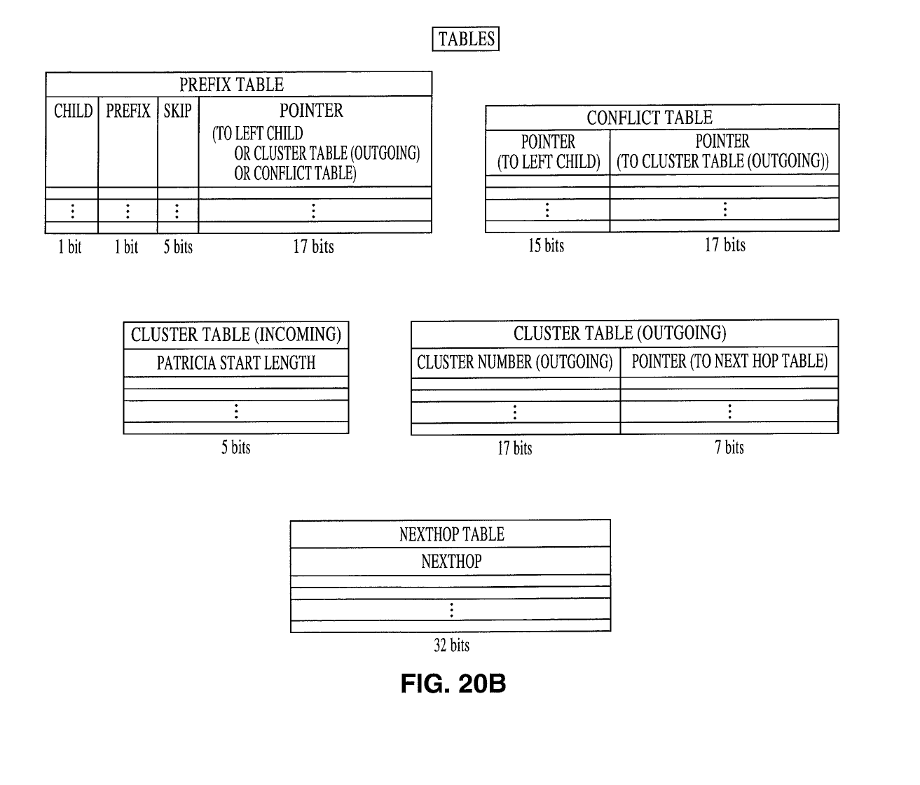

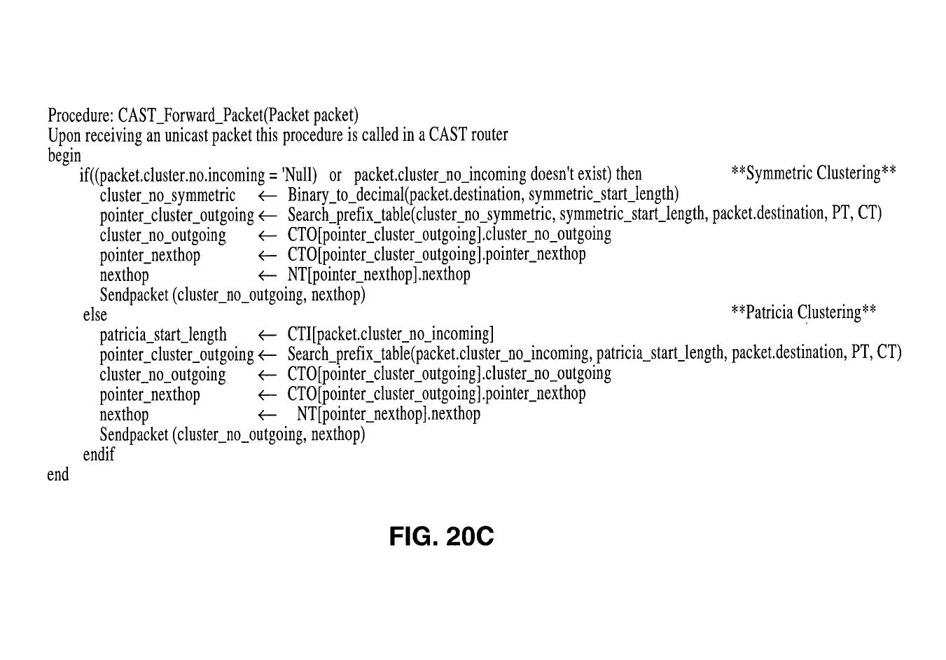

FIG. 20 (FIG. 20A through FIG. 20C) shows the data structures maintained in a CAST router which follows both symmetric and Patricia clustering. A CAST router of symmetric clustering and Patricia clustering maintains five tables: prefix table, conflict table, cluster_table_incoming, cluster_table outgoing, and nexthop_table. The prefix table stores all prefixes of a routing table. We use a part of LPC trie data structure described in Nilsson, S. et al., “Fast address look-up for Internet routers”, Proceedings of IFIP 4^{th} International Conference on Broadband Communications (BC '98), pages 11-22, 1998, incorporated herein by reference, to store the prefix entries in the prefix table. Each row in the prefix table represents a node at the Patricia trie. Two children of a node on the Patricia trie are stored in two consecutive rows of the prefix table. Thus the prefix table stores only the pointers to the left child. This reduces the memory requirement.

To represent a leaf node, the “child” field is marked as “0”. Similarly, to represent a prefix entry the “prefix” field is marked as “1”. If a node in the Patricia trie represents both a prefix entry and a non-leaf node then the conflict table is used to store the pointer to the left child and the pointer to the cluster_table_outgoing. Cluster_table_incoming stores the starting prefix length of each cluster in Patricia clustering. Cluster_table_outgoing stores the cluster numbers (outgoing) and the pointers to the next hop table.

FIG. 20 also shows the CAST algorithm followed in a router which performs both symmetric and Patricia clustering. A packet with a “Null” Cluster Number (Incoming) or without a Cluster Number (Incoming) performs a CAST lookup with symmetric clustering. Similarly a packet with a Cluster Number (Incoming) performs a CAST lookup of Patricia clustering. Variables “symmetric_start_length” and “patricia_start_length” store the starting prefix length of the cluster in symmetric and Patricia clustering respectively. Procedure “Binary_to_decimal” produces the symmetric Cluster Number (Incoming) from the inputs: the destination address of the packet, number of bits used in symmetric clustering (“symmetric_start_length”). Procedure “Search_prefix_table” begins lookup at the Cluster Number (Incoming) specified in its first input parameter and also with a starting prefix length specified in its second input parameter. Thereafter it performs a Patricia trie lookup by using its destination address and finally it produces a pointer to cluster table (outgoing).

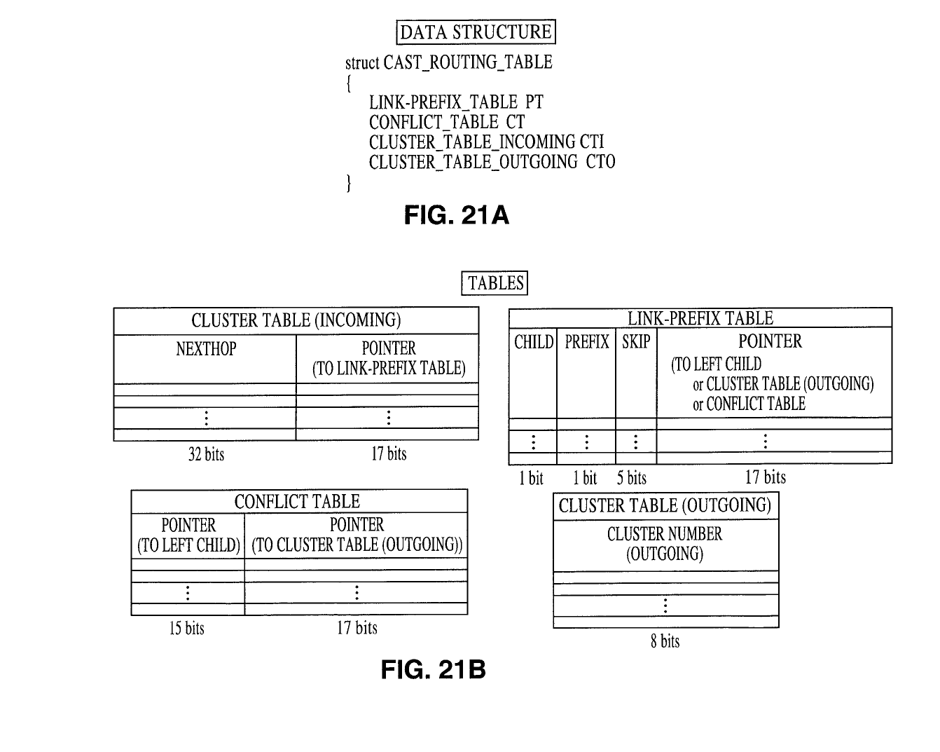

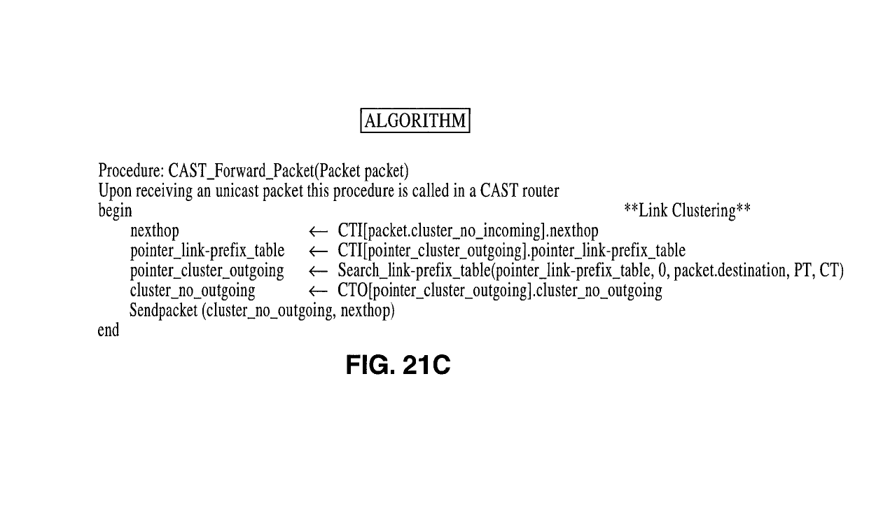

Procedure “Send_packet” replaces the Cluster Number (Incoming) of the packet by Cluster Number (Outgoing) and then it forwards the packet to the specified next hop. FIG. 21 (FIG. 21A through FIG. 21C) shows the data structures maintained in a CAST router of link clustering. A CAST router with link clustering maintains four tables: link-prefix table, conflict table, cluster_table_incoming, cluster_table_outgoing. Cluster_table_incoming stores the next hop links and pointers to link-prefix table. In link-prefix table, all clusters formed by link clustering are stored in form of Patricia trie.

1.5 CAST in Multicast Switching

CAST is also applicable to the multicast. It substantially expedites the lookup time in multicast lookup with low memory usage and low update time. It also compresses the multicast routing table with a further level of aggregation of the multicast addresses.

A multicast CAST packet specifies a cluster number in addition to the address of the intended multicast group. Upon arrival to a router it jumps to a particular cluster and begins searching all the multicast entries of that cluster only. Thereafter it gets the best match and packet is forwarded to the corresponding next hop links. In the same way total lookup time of the multicast CAST scheme is the time it takes to search all the entries in that particular cluster. Next comes the question of clustering scheme or how to group together multicast routing table entries.

CAST can be accommodated easily in a particular multicast domain with a simple modification of the multicast protocol and there is no need to maintain trie, data structure in CAST. Hence, like link clustering in unicast, the multicast routing table can be clusterized on the basis of next hop of the entries. The entries which have same next hop links are grouped together and put into a cluster.

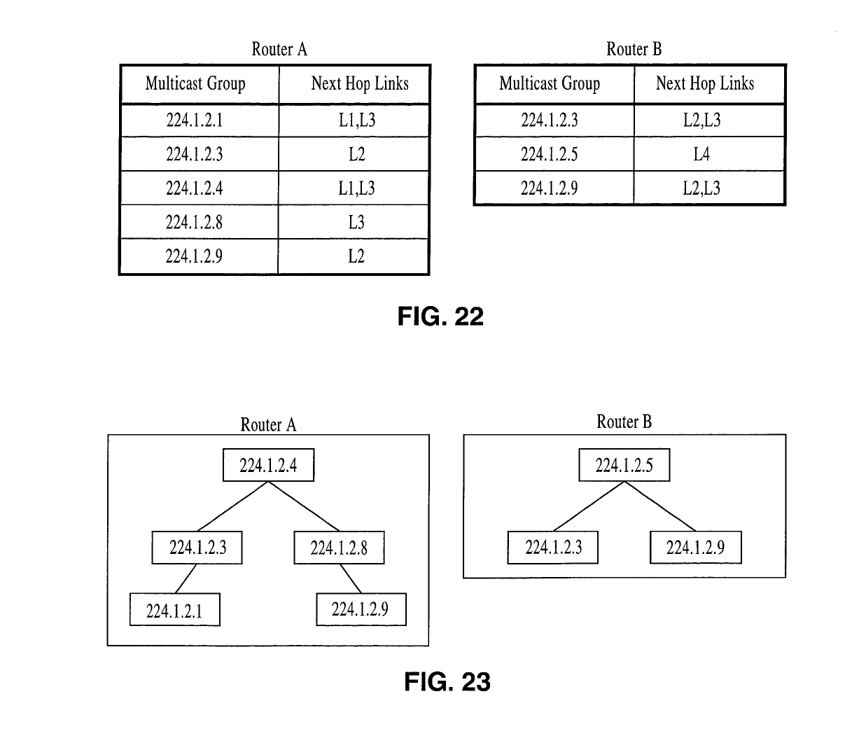

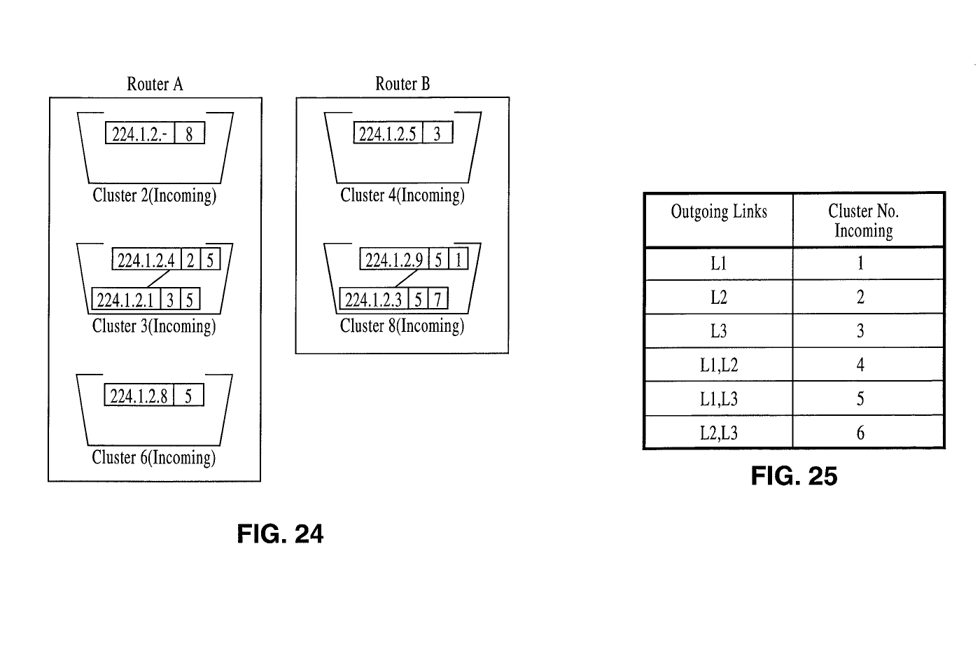

FIG. 22 and FIG. 23 show the shared tree (PIM-SM, OBT) multicast routing tables of routers “A” and “B” and associated AVL tries, respectively. FIG. 24 shows how the routing tables of router “A” and “B” are clusterized by clustering on the next hop links. As an example, in router “B” group entries “224.1.2.3” and “224.1.2.9” are grouped together into a cluster as they share the same next hop links.

We derive an equation which can be used to assign a Cluster Number (Incoming) to a particular group entry. Assignment of a Cluster Number (Incoming) to a multicast group entry is a function (Eq. 1.1) of the total number of next hop links of a router, total number of next hop links of that multicast group entry and the link ids of each next hop link of that entry.

Cluster No (Incoming)=f(no_of_links_of_router, no_of_links_entry, nexthop_link_ids_of_entry) (1.1)

Cluster numbers are assigned, first in an increasing order of link identifications (id's) and then in an increasing order of the number of links in an entry. FIG. 25 shows the assignment of cluster numbers (incoming) in router “A”.

To derive an equation, we choose an router with a total of d next hop links and a multicast group entry with m next hop links of values: La₁, La₂, . . . , Laₘ where a_{1≦a}₂≦. . . ≦aₘ . . . ≦k. Cluster Number (Incoming) of that multicast group entry lies after the Cluster Numbers (Incoming) of all d next hop links taken one at a time (a total of ^{d}C₁), taken two at a time (a total of ^{d}C₂), and up to all d next hop links taken (m−1) at a time (a total of ^{d}Cₘ₋₁), and it also comes after all the sequences of d next hop links taken m at a time those come before the next hop link sequence (La₂, La₂, . . . , Laₘ) of that entry. The total number of the sequences out of d next hop links taken m at a time, those come before the next hop link sequence of that entry are [(a₁+a₂+. . . +aₘ)−(Σᵢ₌₁^{m}i−1)] where (a₁+a₂+. . . +aₘ) is the summation of next hop link ids of that multicast group entry and (Σᵢ₌₁^{m}i−1) is the offset. Cluster number equation Eq. 1.2 summarizes the result.

$${[}^{d} {C}_{1} + {}_{}^{d}{C}{}_{2}^{} + … {}^{d} {C}_{m - 1} ] + [ ( {a}_{1} + {a}_{2} + … {a}_{m} ) - \frac{m ( m + 1 )}{2} + 1 ] \qquad ( 1.2 )$$

The cluster numbers (incoming) are assigned to the clusters formed in routers “A” and “B” (FIG. 24) using Cluster Number (Incoming) equation (Eq. 1.2).

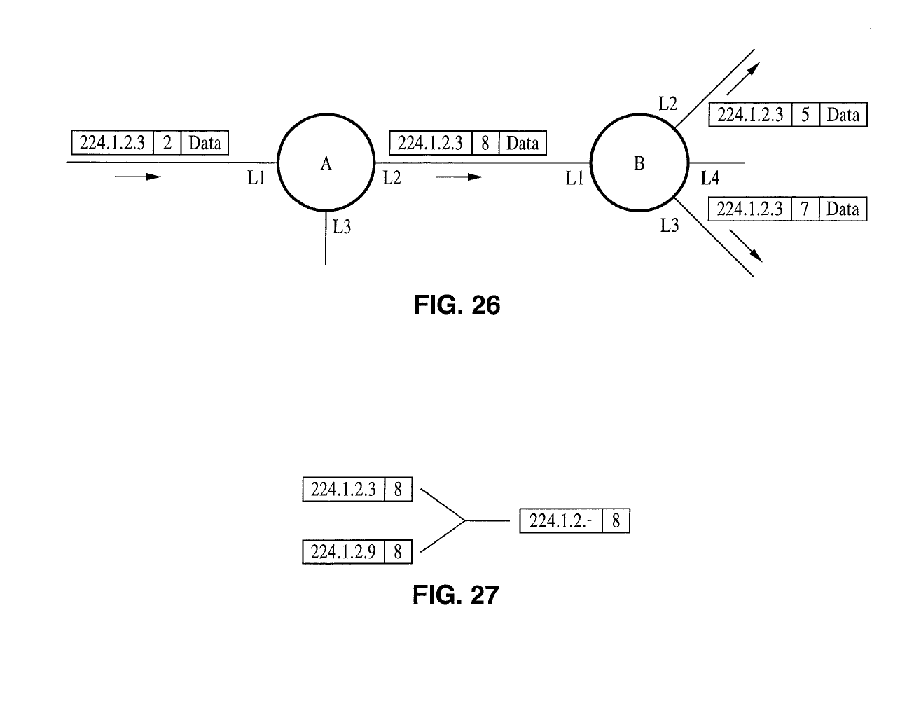

From a network point of view, a multicast CAST packet reaches a CAST router in the network along with a Cluster Number (Incoming) and a multicast group address (for shared tree multicast protocol). Thereafter the router begins lookup at the routing table and finds a multicast group entry that matches the multicast group address of the packet. At the end, the CAST router forwards the packet to all the next hop links of the matched entry, by replacing the old Cluster Number (Incoming) with new different cluster numbers (outgoing) for different next hop links. We integrate router “A” and router “B” to form a network model shown in FIG. 26.

Thus, upon arrival of a packet with multicast group address “224.1.2.3” and the cluster number “2” (incoming), lookup begins at cluster “2” of router “A” and it finds the entry “224.1.2.-” (aggregated entry, FIG. 27) as best match of the packet. According to the entry “224.1.2.-” the packet is then forwarded to the next hop link L2 with a replacement of old Cluster Number (Incoming) by a new cluster number of “8” (outgoing). In the same way at router “B”, the packet matches entry “224.1.2.3” of cluster “8” and goes out in link L2 and L3 with the new cluster numbers (outgoing) of “5” and “7” respectively.

Note that, in today's routing tables, aggregation of two multicast group entries is not possible as it is very unlikely that two consecutive entries share the same next hop links. By clustering on the basis of the next hop links, CAST achieves a further level of aggregation in the multicast routing table. In a normal multicast aggregation, two consecutive entries sharing the same next hop links can be combined to a single entry. In contrast, with CAST based on clustering on the next hop links, any two entries of a particular cluster can be aggregated together provided that the new cluster numbers (outgoing) of those entries are same for all their next hop links. More specifically two different multicast group entries of a CAST router can be aggregated together, if they share the same next hop links in that router and also in all their immediate next hop routers (children routers in the multicast tree). In CAST with link clustering, 2^{d+1} clusters are formed where d is the number of next hop links. Thus “CAST in multicast” achieves high aggregation power, if G>>2^{d+1} where G is the number of multicast group entries in a multicast routing table and d is the number of next hop links of the router. FIG. 27 shows how entries “224.1.2.3” and “224.1.2.9” with a common cluster number “8” (outgoing) are combined together to form entry “224.1.2.-”.

1.6 Analytical Evaluation of CAST

This section describes an analytical evaluation of CAST according to the design parameters: applicability of the scheme, table lookup time, memory size, and update time.

1.6.1 Applicability of the Scheme

CAST is applicable to all hop routers on the path of a packet from its source to the destination. At the first hop of a packet “CAST with symmetric clustering” is used. Similarly a packet performs “CAST with Patricia clustering” or “CAST with link clustering” at the second and successive hop routers. Our results (Section 2) show that “CAST with Patricia clustering” performs better than “CAST with symmetric clustering” and “CAST with link clustering”.

1.6.2 Table Lookup Time

The lookup time equation and the packet processing power equation are calculated for CAST with different clustering schemes. For calculation purpose we choose a router “Z” with n number of prefix entries in its routing table along with k clusters formed by CAST.

At the beginning we make an assumption on the Patricia trie data structure to simplify the calculation in our analysis. A Patricia trie stores all n prefix entries of the routing table in form of a path compressed binary prefix trie and the lookup begins from the root node. Results of LPC Scheme shows that the average number of lookups in a Patricia trie approximately matches with that of an AVL trie, where each node represent a prefix entry. Henceforth for simplicity in analysis, we approximate the Patricia trie to a trie where every node represents a prefix entry and which is evenly balanced in the height at every direction.

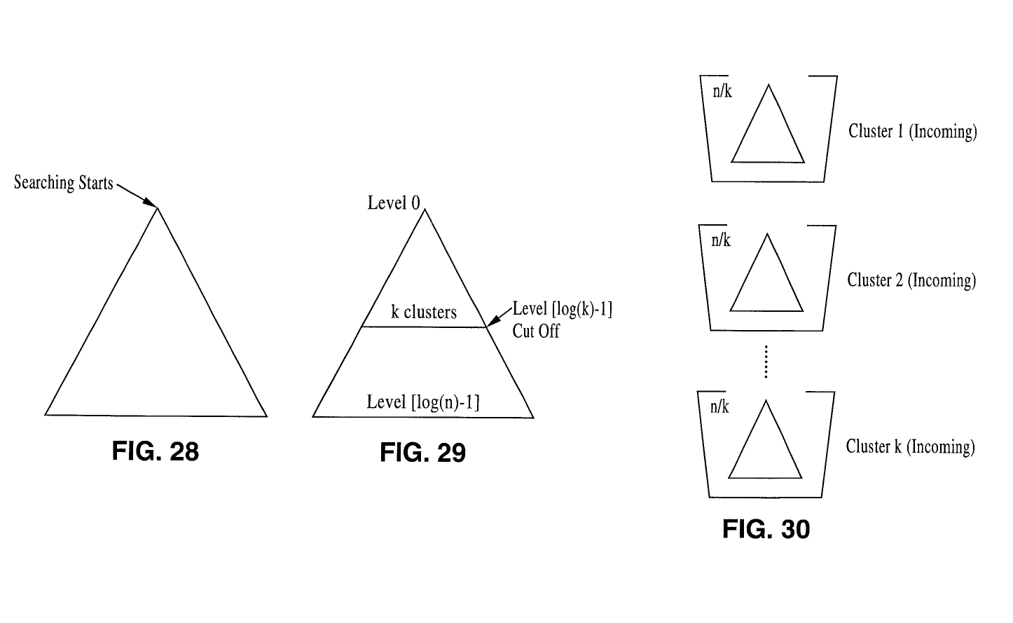

On average, log(n) nodes are accessed per lookup in a Patricia trie as illustrated in FIG. 28). Thus Patricia trie has an average lookup time of log(n) memory accesses.

In CAST with Patricia clustering, a cutoff at a particular level makes each node on and above the cutoff level, a cluster (incoming). Henceforth, a cutoff at the level [log(k)−1] forms k-clusters (incoming) (FIG. 29). A Patricia trie contains 2^{[log(k)-}1]=k/2 nodes at the level [log(k)−1]. Therefore, a level [log(k)−1] cutoff forms k/2 clusters (incoming) at the level [log(k)−1] and (k−k/2)=k/2 clusters (incoming) above the level log(k)−1 ].

Each cluster (incoming) above the level [log(k)−1] contains a single prefix entry. Thus for all the clusters (incoming) above the level [log(k)−1] containing a total of k/2 prefix entries, a lookup takes a single memory access to find a match. Similarly, on average [log(n)−(log(k)−1)] memory accesses are required for each cluster at the level [log(k)−1], which is the height of the each cluster at the level [log(k)−1].

Eq. 1.3 calculates the average lookup time of CAST with Patricia clustering, assuming each entry of the routing table is accessed with equal probability.

$${L}_{CAST ( Patricia Clustering )} = \frac{( k / 2 ) * [ 1 ] + ( n - k / 2 ) * [ log ( n ) - log ( k ) + 1 ]}{( k / 2 ) - ( n - k / 2 )} \qquad ( 1.3 )$$

L_{CAST} denotes the lookup time of CAST in terms of number of memory accesses, n denotes the total number of entries in the routing table, k denotes the number of clusters formed by CAST with Patricia clustering. Eq. 1.4 simplifies Eq. 1.3 and can be used to calculate the lookup time of CAST with Patricia clustering.

$${L}_{CAST ( Patricia Clustering )} = \frac{( k / 2 ) + ( n - k / 2 ) * [ log ( n / k ) + 1 ]}{n} \qquad ( 1.4 )$$

The lookup time of CAST can be minimized with an equal distribution of prefix entries over k clusters. We call this clustering scheme the “best possible clustering” technique. For a given number of clusters this clustering scheme achieves the maximum lookup power over all other clustering techniques. FIG. 30 shows best possible clustering with an equal distribution of n prefix entries of router “Z” over k clusters such that each cluster contains n/k prefix entries and maintains Patricia trie data structure. Henceforth, CAST with “best possible clustering” has an average lookup time of log(n/k). In symmetric clustering, all the entries are almost equally distributed among the clusters. Thus CAST with symmetric clustering has an average lookup time of log(n/k) (Eq. 1.5).

L_{CAST(Symmetic Clustering)}=log(n/k), k is bounded (1.5)

But in this clustering scheme there is a limitation on the number of clusters and thus the value of k is bounded. The average lookup time of CAST with link clustering is bounded by the lookup time of the cluster with maximum number of entries (Eq. 1.6).

L_{CAST(Link Clustering)}≦log(m), m is max entries in a cluster, m≦n (1.6)

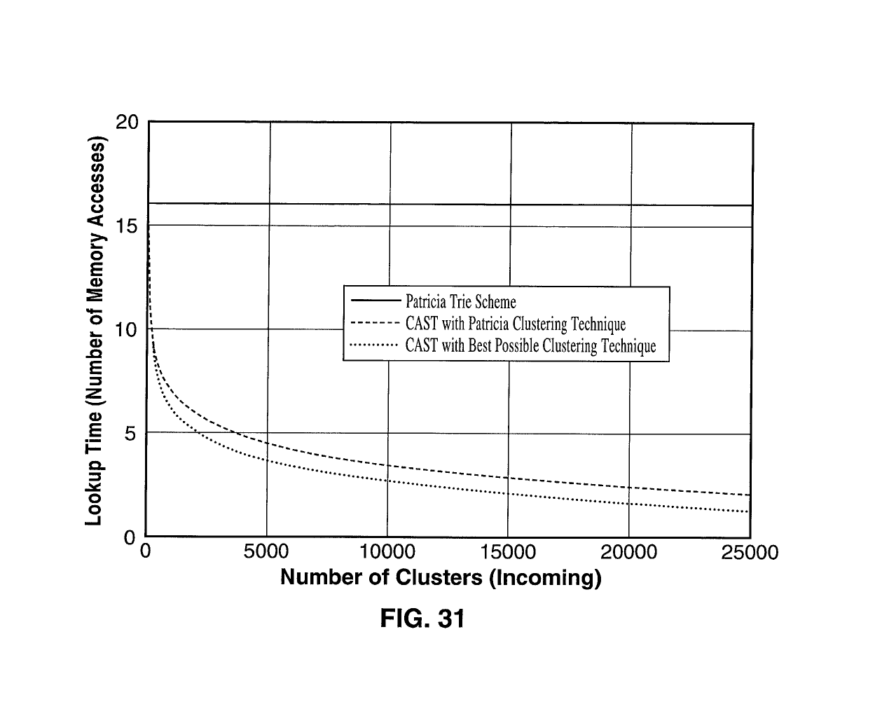

FIG. 31 shows the lookup powers obtained in Patricia trie, CAST with Patricia clustering, and in CAST with best possible clustering, as a function of number of clusters and with a router of 65635 (n=65635) prefix entries. The Patricia trie scheme has an average lookup time of log(65635)-16 memory accesses. Lookup time of CAST decreases exponentially with an increase in the number of clusters. By maintaining only 1000 clusters, the average number of memory accesses can be scaled down to five. More interestingly, the lookup time curve of CAST with Patricia clustering almost matches with that of the CAST with best possible clustering technique.

Similarly, we derive the switching speed equation. The switching speed of a lookup scheme is defined as how many bits a router can process per second. Thus switching speed (bits per second) (Eq. 1.7) is the normal product of the average packet size (bits) and the packet processing power (packets per second) where the packet processing power is the inverse of the lookup time (seconds).

$$\begin{matrix}SwitchingSpeed = ( AveragePacketSize ) * ( PacketProcessingPower ) \\ = ( AveragePacketSize ) / ( LookupTime )\end{matrix} \qquad ( 1.7 )$$

The switching speed equation (Eq. 1.8) is obtained with an integration of Eq. 1.3 and Eq. 1.7 where S_{CAST} denotes the switching speed in bits per second.

$${S}_{CAST ( Patricia Clustering )} = \frac{1000}{[ \frac{( k / 2 ) + ( n - k / 2 ) * log ( n / k ) + 1}{n} ] * [ 10 * {10}^{- 9} ]} \qquad ( 1.8 )$$

Lookup time (seconds) is the product of the lookup time (number of memory accesses) and the memory cycle time. For calculation purpose, we choose an average Internet packet size of 1000 bits and a cache of 10 ns access time because CAST data structure fits into a cache.

Using Eq. 1.8 it can be seen that CAST with 25000 clusters (incoming) (n=65635) achieves a switching speed of 53 Gbps which is way above the line speed of Gbps OC-768 optical fiber line. By making all the entries a cluster (incoming) (k=65635), a switching speed of 100 Gbps can be achieved. This confirms that CAST is well suited for next generation high speed optical fiber lines.

1.6.3 Memory Size

It will be appreciated that in CAST with any clustering scheme, each prefix entry stores the additional field Cluster Number (Outgoing) (FIG. 8, FIG. 20, FIG. 21). In addition, a CAST router maintains a Cluster Number (Incoming) table (FIG. 20). Thus, the additional memory requirement in CAST (regardless of the clustering technique) is the additional memory required to store Cluster Numbers (Outgoing) and cluster table (incoming). In CAST with Patricia, symmetric and link clustering, the cluster tables (incoming) are very small in size (FIG. 20, FIG. 21). In FIG. 20 and FIG. 21, seventeen and eight bits are allocated accordingly to store Cluster Numbers (Outgoing). Thus, the number of bits to store the Cluster Numbers (Outgoing) can be varied according to the need. If each next hop router maintains k clusters, then log(k) bits are sufficient enough to store all the cluster numbers (outgoing) assuming that it does not require bit length to be multiple of eight. Henceforth, a CAST router with n prefix entries consumes an additional space of n*log(k) bits.

The memory equation (Eq. 1.9) shows the result described above, where M_{CAST} and M_{patricia} denote the memory requirements in bits, of CAST and Patricia trie respectively.

M_{CAST(For Any Clustering)}=M_{Patricia}+n*log(k) (1.9)

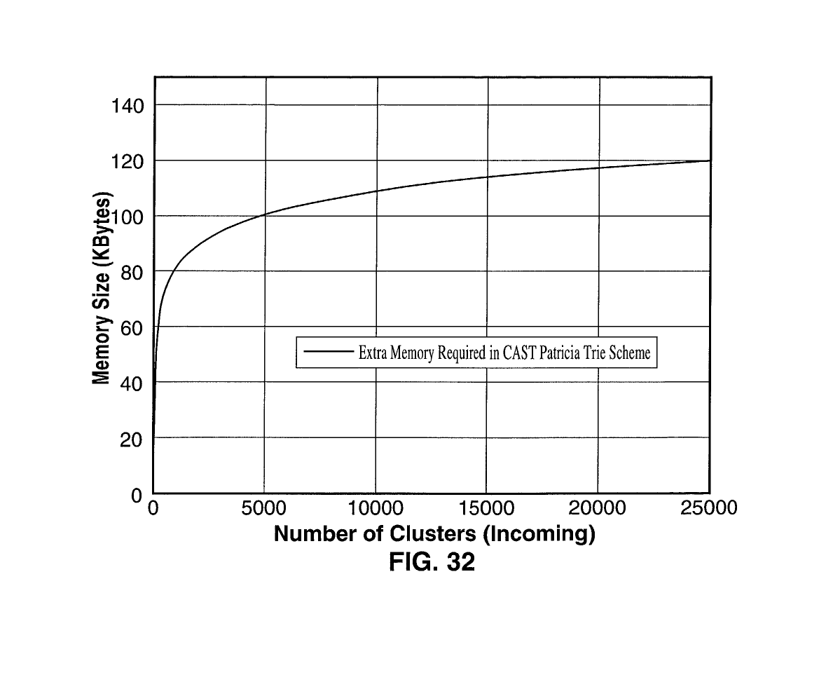

FIG. 32 shows the additional memory requirement n*log(k) in CAST as a function of number of clusters in each next hop router. It is also observed that CAST consumes as low as 120 KBytes of memory for as large as for 25000 clusters in each next hop router. As the memory requirement of Patricia trie scheme is low, CAST has a low memory requirement (Eq. 1.9) and it can be fit into a cache.

1.6.4 Update Time

Update time of CAST is also calculated as a function of the number of entries in the routing table. In CAST with Patricia clustering and symmetric clustering, the update time is the total time to update the routing table data structure with an additional time to communicate the Cluster Number (Incoming) to the previous hop routers. Regardless of the lookup scheme when a routing table entry is added/deleted to/from a routing table, the router sends a routing update to all its neighbors. Since the Cluster Numbers (Incoming) are sent along with routing updates this additional time can be neglected. Thus, the update time in CAST with Patricia clustering or CAST with symmetric clustering is the total time to update its Patricia trie data structure which equals to the update time of a Patricia trie scheme. Because the update time of Patricia trie scheme is as low as log(n), it can be said that CAST with Patricia clustering has a low update time. The update time of CAST with link clustering is bounded by the update time of the cluster with maximum number of entries. Eq. 1.10 and Eq. 1.11 summarize the result.

U_{CAST(Patricia Clustering)}=U_{CAST(Symmetric Clustering)}=U_{Patricia Trie Scheme}=log(n) (1.10)

U_{CAST(Link Clustering)}≦log(m), m is the max entries in a cluster, m≦n (1.11)

2. Simulation and Implementation Experiments

This section describes the results obtained from simulation and actual implementation experiments along with a comparison between CAST and other schemes.

2.1 Discussion of Unicast Results

Unicast simulations were performed with a comparison between Patricia trie, AVL tree, Lulea, LPC, and DRAM schemes of non-cooperative lookup; Tag Switching, IP switching schemes of cooperative-lookup; and CAST with Patricia and Symmetric clustering schemes of hybrid lookup. Actual implementation experiments were performed along with a comparison between Patricia trie, LPC trie, CAST with Patricia and Symmetric clustering schemes.

2.1.1 Metrics Used

The simulations were performed on data collected from the routing tables of five big backbone routers: Mae-East, Mae-West, Pac-Bell, MDS and PAIX. CAST simulation modules were implemented in the C programming language where the compilation was performed using the gnu c compiler (gcc) with a level four optimization. The cache and DRAM access times were chosen as 10 ns and 50 ns respectively. The maximum size cache available at the time was 1000 KBytes. Thus, in our simulation, we considered all schemes of less than 1000 KBytes can be fit into a cache and perform lookup with a memory access time of 10 ns.

In the simulation and the actual implementation, data packets were artificially generated to calculate the average packet processing power and the average update time. The sample size in our experiment was 5 million data packets. The results were also obtained from the actual implementation of CAST modules in a Sparc Ultra-2 336 MHz server with 16 KBytes of level 1 cache of 20 ns access time, 256 KBytes of level 2 cache of 45 ns memory access time, and 256 Mbytes of main memory of 300 ns memory access time.

To calculate the percentage deaggregation between two routers, simulations were performed between the Mae-East and AT&T routers. Our simulations on a small data size of 1000 prefix entries showed that a total of 6.97% deaggregation takes place from router Mae-East to AT&T router with a breakup of 6.21% and 0.76% of level 1 deaggregation and level 2 deaggregation respectively. Thus, throughout our simulation we assumed that same percentage of deaggregation is followed between any two backbone routers.

In simulation of the CAST with Patricia scheme, it was assumed that all packets come with a valid cluster number (not “Null”). It was also assumed that in case of a deaggregation, the tag switching scheme performs a full FIB lookup instead of a TIB lookup to prevent duplication of packets. For IP switching simulation, it was assumed that 92% of the packets were switched directly by layer 2 of the switch. Because of lack of data from the backbone routing tables we assumed that the percentage of aggregation in CAST with link clustering is “0”.

2.1.2 Discussion of Simulation Results from Mae-East Router

In our unicast simulation results obtained from the Mae-East router we found that a CAST with Patricia clustering scheme with 43894 clusters (incoming) achieved a lookup time of 92.42 MPPS along with a memory usage of 394 KBytes and an average update time of 19.65 memory accesses. The Patricia trie scheme alone achieved a low packet processing power of 4.99 MPPS but this scheme consumed less memory than CAST schemes. The average update time of CAST with Patricia clustering was higher than that of Patricia trie because CAST with Patricia clustering takes more memory accesses to update a deaggregated prefix. CAST with Patricia clustering with 21571 clusters (incoming) had a lookup power of 18.66 MPPS which is greater than the lookup power of the Lulea scheme. Update time decreased with a decrease in the number of clusters (incoming) but the memory size remained the same as the same number of bits are used for Cluster Number (Outgoing). CAST with symmetric clustering obtained a lookup power of 6.21 MPPS which is better than lookup power obtained by Patricia trie scheme. CAST with link clustering achieved packet processing power more than that of CAST with symmetric clustering but less than packet processing power of CAST with Patricia clustering. However, memory usage in CAST with Patricia clustering and CAST with link clustering was more than that of CAST with symmetric clustering.

An AVL tree scheme of non-cooperative lookup achieved a processing power of 6.47 MPPS along with a higher memory usage than CAST arid Patricia trie. The Lulea scheme had the lowest memory requirement among all other schemes as it consumed only 198 KBytes. But this scheme scaled badly in update time. LPC trie achieved a processing power of 35.84 kAPPS. But its memory requirement was 901 KBytes is higher than that of CAST, Patricia, AVL or Lulea schemes. In contrast, the LPC scheme scaled very well in update time with an average of update time of 2.82 memory accesses per second. A lookup power of 19.98 MPPS was achieved by DRAM technique with a high memory usage of 33 Mbytes.

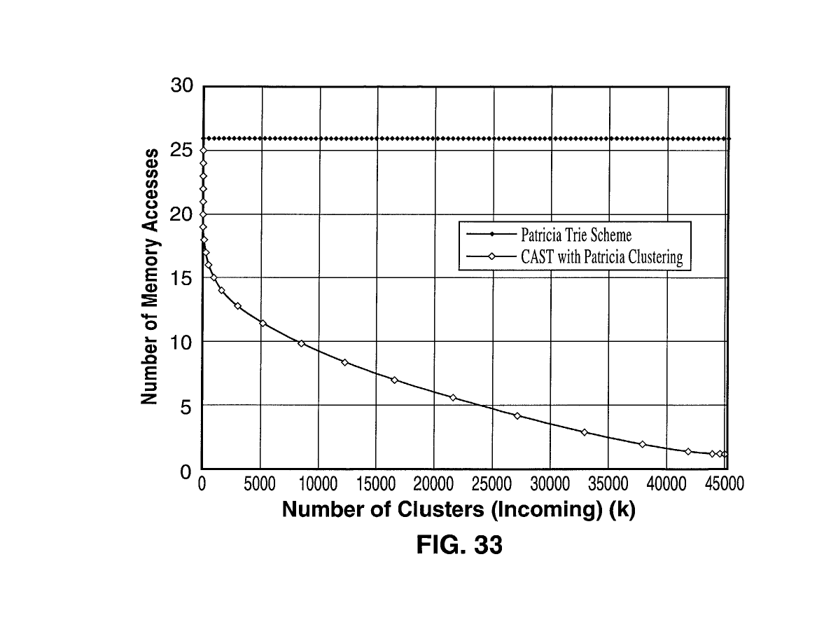

Tag switching achieved a processing power of 36.36 MPPS. A full FIB lookup to prevent the duplication of packets in case of a deaggregation, decreased its overall performance. Tag switching also scaled badly in memory usage and update time. On the other hand, IP Switching obtained a packet processing power of 40.98 MPPS with its memory usage and update time almost equal to those of tag switching. FIG. 33 shows the number of memory accesses in CAST with Patricia clustering as a function of number of clusters. The curve obtained in FIG. 33 matched our analytical result discussed in Section 1. FIG. 33 also demonstrates how CAST can be scaled as a function of lookup time by varying the total cluster numbers (incoming).

2.1.3 Discussion of Simulation Results from Mae-West Router

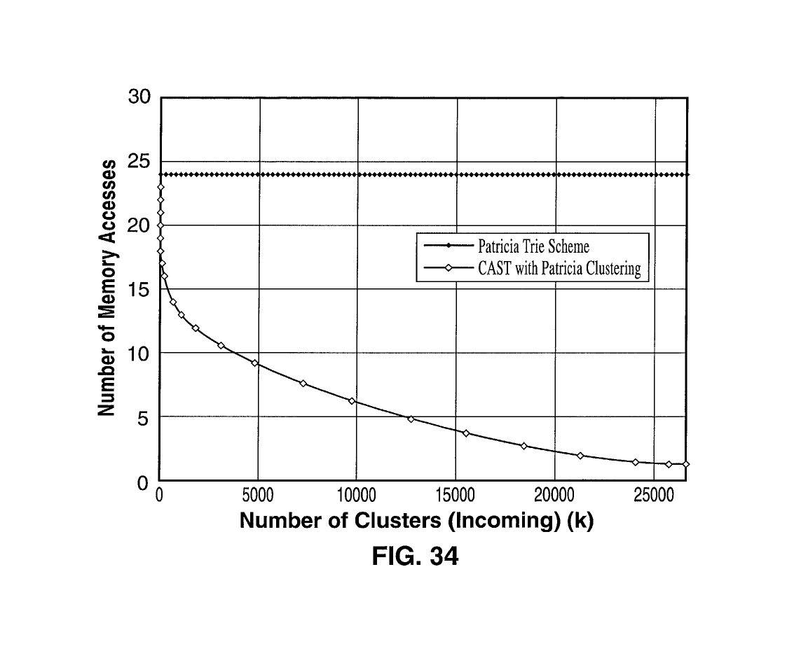

Unicast simulation results were also obtained from the Mae-West router (FIG. 34). Here, CAST with Patricia clustering with 25681 clusters (incoming) achieved a lookup time of 90.49 MPPS along with a memory usage of 231 KBytes and an average update time of 18.31 memory accesses. The Patricia scheme achieved a low packet processing power of 5.19 MPPS but this scheme consumed less memory than CAST schemes. The average update time of CAST with Patricia clustering was higher than that of Patricia trie because CAST with Patricia clustering takes more memory accesses to update a deaggregated prefix. In the Mae-West router, the memory usage of CAST with Patricia clustering of 9724 clusters was less than that of Patricia clustering of 25681 clusters. CAST with link clustering achieved a processing power of 9.44 MPPS which was better than that of CAST with symmetric clustering. However, memory usage in CAST with Patricia clustering and CAST with link clustering was more than that of CAST with symmetric clustering.

An AVL tree scheme of non-cooperative lookup achieved a processing power of 6.80 MPPS along with a higher memory usage than CAST and Patricia trie. The Lulea scheme had the lowest memory requirement among all other schemes as it consumed only 121 KBytes. But this schemes scaled badly in update time with a higher number of memory accesses. LPC trie achieved a processing power of 38.76 MPPS, but its memory requirement of 528 KBytes was higher than that of CAST, Patricia, AVL or Lulea schemes. In contrast, the LPC scheme scaled very well in update time with an average of update time of 2.59 memory accesses per second. A lookup power of 19.96 MPPS was achieved by DRAM technique with a high memory usage of 33 Mbytes.

Tag switching achieved a processing power of 38.31 MPPS. A full FIB lookup to prevent the duplication of packets in case of a deaggregation decreased its overall performance. Tag switching also scaled badly in memory usage and update time. On the other hand, IP Switching obtained a packet processing power of 40.65 MPPS with its memory usage and update time almost equal to those of tag switching. FIG. 34 shows the number of memory accesses in CAST with Patricia clustering as a function of number of clusters. The curve obtained in FIG. 34 matches our analytical result discussed in Section 1. FIG. 34 also demonstrates how CAST can be scaled by varying cluster number as a function of lookup time.

2.1.4 Discussion of Simulation Results from Pac-Bell Router

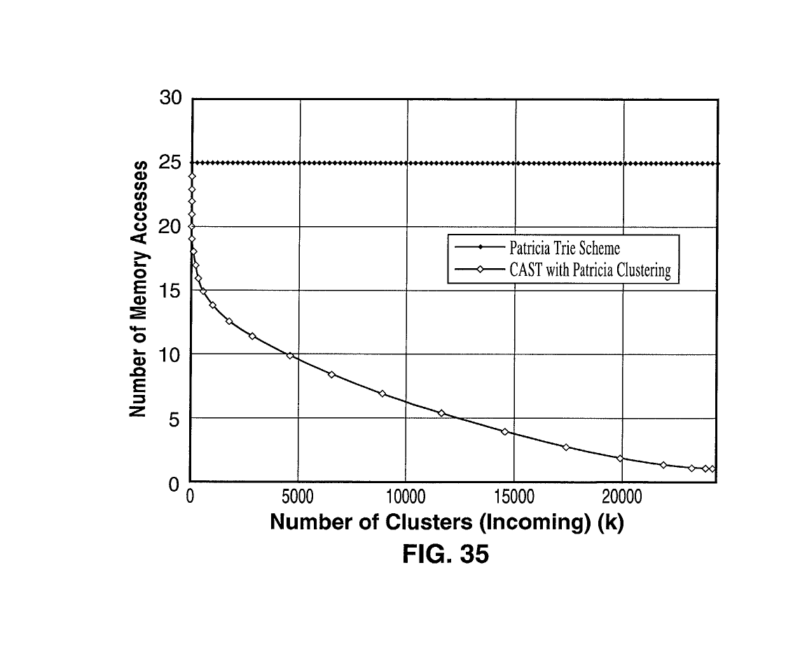

FIG. 35 shows the unicast simulation results obtained from Pac-Bell router. CAST with Patricia clustering with 24031 clusters (incoming) achieved a lookup time of 86.73 MPPS along with a memory usage of 213 KBytes and an average update time of 18.39 memory accesses. The Patricia scheme achieved a low packet processing power of 5.21 MPPS but this scheme consumed less memory than CAST schemes. The average update time of CAST with Patricia clustering was higher than that of Patricia trie because CAST with Patricia clustering takes more memory accesses to update a deaggregated prefix.

An AVL tree scheme of non-cooperative lookup achieved a processing power of 6.86 MPPS along with a higher memory usage than CAST and Patricia trie. The Lulea scheme had the lowest memory requirement among all other schemes as it consumed only 114 KBytes. But this schemes scaled badly in update time. LPC trie achieved a processing power of 39.06 MPPS, but its memory requirement of 504 KBytes was higher than that of CAST, Patricia, AVL or Lulea schemes. In contrast, the LPC scheme scaled very well in update time with an average of update time of 2.58 memory accesses per second. A lookup power of 19.98 MPPS was achieved by DRAM technique with a high memory usage of 33 Mbytes.

2.1.5 Discussion of Simulation Results from MDS Router

Simulation results from AADS routers had the same characteristics. CAST with Patricia clustering with 13716 clusters (incoming) achieved a lookup time of 91.14 MPPS along with a memory usage of 99 KBytes and an average update time of 18.01 memory accesses. The Patricia scheme achieved a low packet processing power of 5.39 MPPS but this scheme consumed less memory than CAST schemes. The average update time of CAST with Patricia clustering was higher than that of Patricia trie because CAST with Patricia clustering takes more number of memory accesses to update a deaggregated prefix.

An AVL tree scheme of non-cooperative lookup achieved a processing power of 7.22 MPPS along with a higher memory usage than CAST and Patricia trie. The Lulea scheme had the lowest memory requirement among all other schemes as it consumes only 76 KBytes. But this schemes scaled badly in update time. LPC trie achieved a processing power of 42.19 MPPS, but its memory requirement of 380 KBytes was higher than that of CAST, Patricia, AVL or Lulea schemes. In contrast, the LPC scheme scaled very well in update time with an average of update time of 2.39 memory accesses per second. A lookup power of 19.99 MPPS was achieved by DRAM technique with a high memory usage of 33 Mbytes.

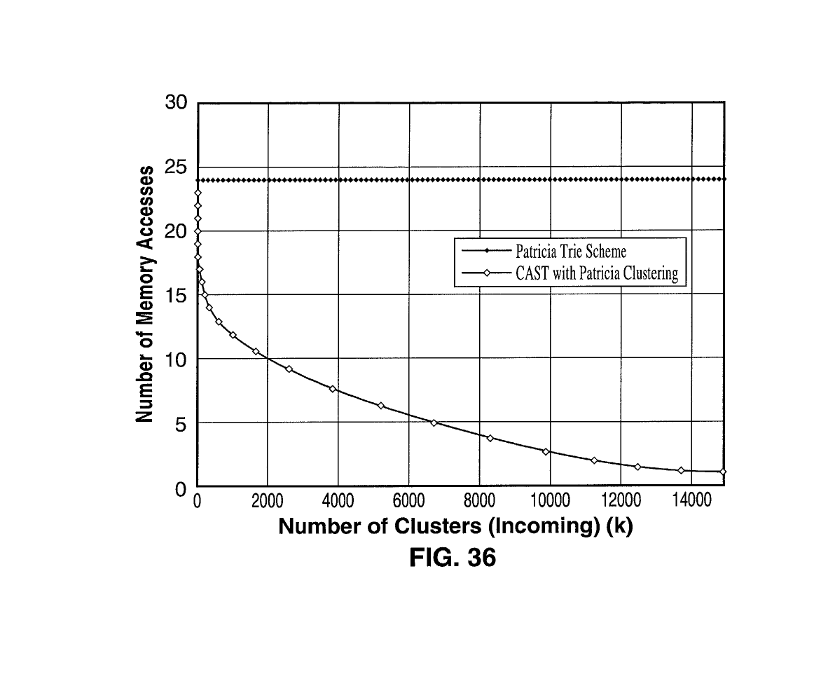

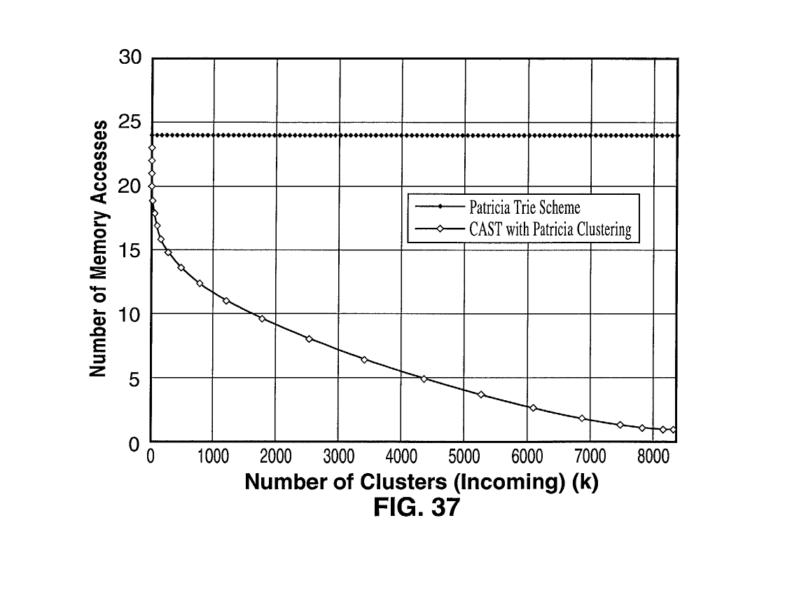

Tag switching achieved a processing power of 38.31 MPPS. A full FEB lookup to prevent the duplication of packets in case of a deaggregation decreased its overall performance. Tag switching also scaled badly in memory usage and update time. On the other hand, IP Switching obtained a packet processing power of 41.67 MPPS with its memory usage and update time almost equal to those of tag switching. FIG. 36 shows the number of memory accesses in CAST with Patricia clustering as a function of number of clusters. The curve obtained in FIG. 36 matches our analytical result discussed in Section 1. FIG. 36 also demonstrates how CAST can be scaled by varying cluster number, as a function of lookup time.

2.1.6 Discussion of Simulation Results from PAIX Router

FIG. 37 shows the unicast simulation results obtained from the Pac-Bell router. CAST with Patricia clustering with 8137 clusters (incoming) achieved a lookup time of 91.74 MPPS along with a memory usage of 73 KBytes and an average update time of 17.24 memory accesses. The Patricia scheme achieved a low packet processing power of 5.57 MPPS but this scheme consumed lesser memory than CAST schemes. The average update time of CAST with Patricia clustering was higher than that of the Patricia trie because CAST with Patricia clustering takes more number of memory accesses to update a deaggregated prefix.

An AVL tree scheme of non-cooperative lookup achieved a processing power of 7.69 MPPS along with a higher memory usage than CAST and Patricia trie. The Lulea scheme had the lowest memory requirement among all other schemes as it consumed only 49 KBytes. But this schemes scaled badly in update time. The LPC trie achieved a processing power of 42.60 MPPS, but its memory requirement of 298 KBytes was higher than that of CAST, Patricia, AVL or Lulea schemes. In contrast, the LPC scheme scaled very well in update time with an average of update time of 2.23 memory accesses per second. A lookup power of 19.94 MPPS was achieved by DRAM technique with a high memory usage of 33 Mbytes.

Tag switching achieved a processing power of 38.31 MPPS. A full FIB lookup to prevent the duplication of packets in case of a deaggregation, decreased its overall performance. Tag switching also scaled badly in memory usage and update time. On the other hand, IP Switching obtained a packet processing power of 42.37 MPPS with its memory usage and update time almost equal to those of tag switching. FIG. 37 shows the number of memory accesses in CAST with Patricia clustering as a function of number of clusters. The curve obtained in FIG. 37 matches our analytical result discussed in Section 1. FIG. 37 also demonstrates how CAST can be scaled by varying cluster number, as a function of lookup time.

2.1.7 Discussion of Actual Implementation Results

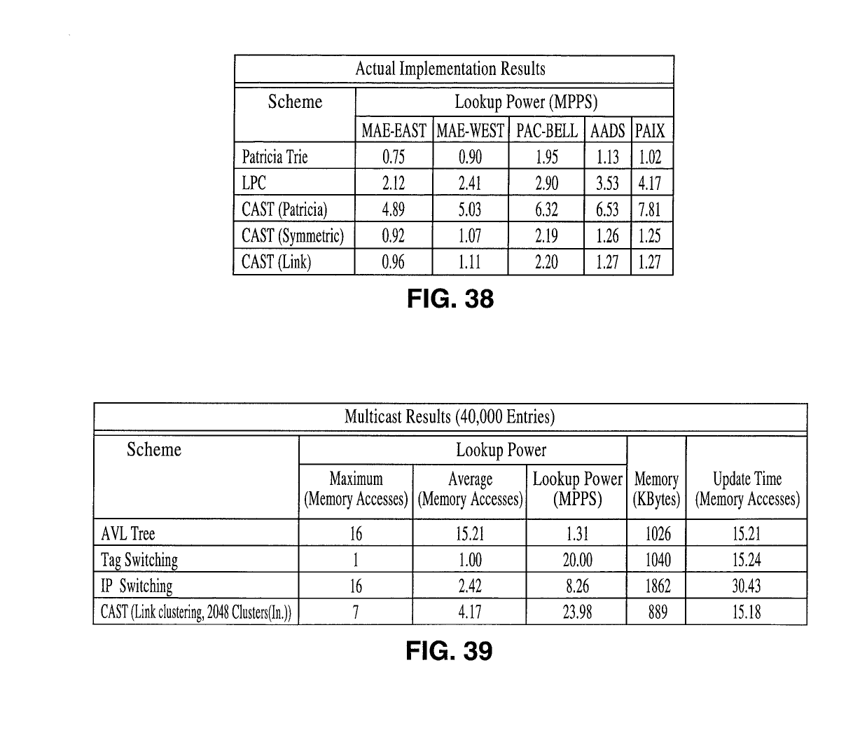

FIG. 38 shows the actual lookup power collected by execution of CAST in a server described above. The lookup power obtained above is low in comparison of our simulation results as the server is not a dedicated router. More specifically it has very low size cache with a very low memory access time. In comparison of actual lookup powers, it can be seen that CAST performs better than Patricia and LPC trie schemes.

2.2 Discussion of Multicast Results

Simulations on multicast lookup schemes were performed along with a comparison between AVL tree scheme of non-cooperative lookup, tag switching and IP switching schemes of cooperative lookup and CAST with link clustering (clustering on next hop links) scheme of hybrid lookup. We chose shared tree multicast protocols for our multicast simulations. As there is no multicast data available in backbone routers, multicast, simulations are performed on artificially generated data. The metrics used for unicast simulations were also used for multicast simulations.

FIG. 39 shows the lookup time, memory size and the update time calculated from a router which contains artificially generated 40000 multicast shared group entries. AVL tree, tag switching and IP switching consumed more than 1000 KBytes which is the maximum size of available cache size. Thus these data structures are stored in main memory which has a lookup time of 50 ns. In contrast CAST with link clustering required a storage of 889 KBytes which can be fit into a cache which has a memory access time of 10 ns. For this reason, the lookup power of CAST is higher than that of tag switching and IP switching, even if a CAST lookup takes higher number of memory accesses than a tag switching or a IP switching lookup. The update time of CAST is also lower than that of AVL tree, tag switching and Patricia trie schemes because compression level of CAST is higher than the other schemes. Thus CAST maintains less number of entries and nodes than AVL tree, tag switching and IP switching schemes and this reduces the update time.

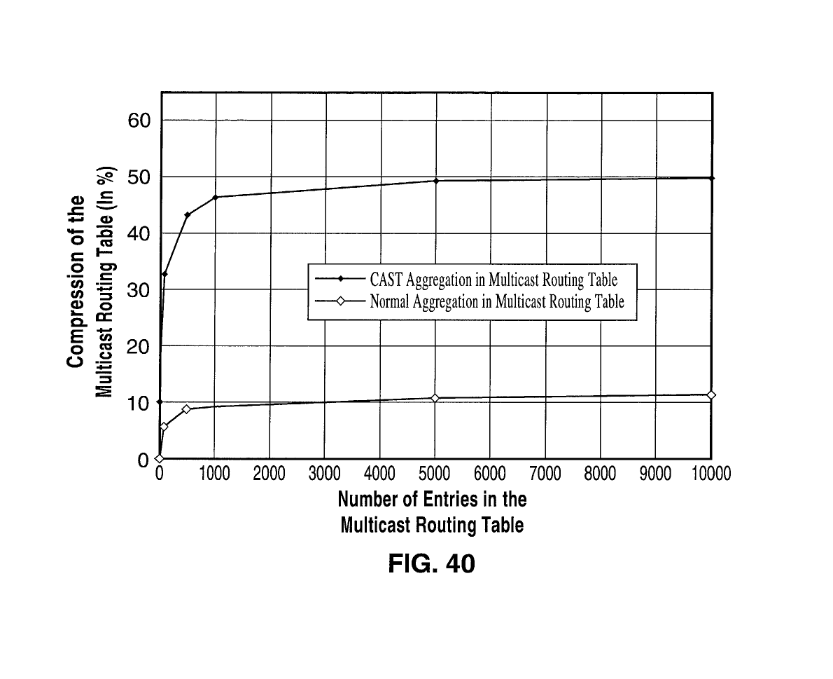

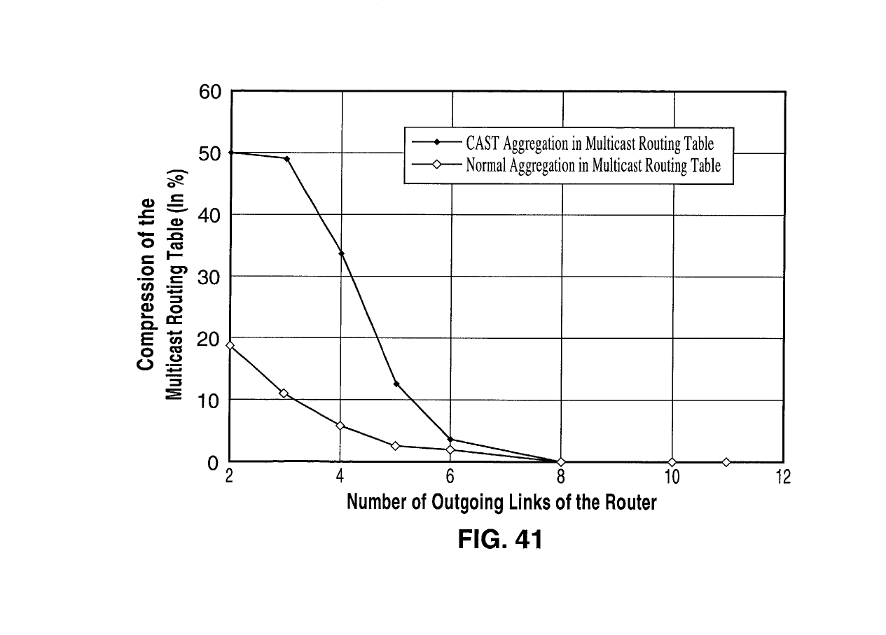

FIG. 40 shows the compression obtained in a multicast CAST routing table in comparison with a normal aggregation method in router. In a normal multicast aggregation, two consecutive entries sharing the same next hop links can be combined to a single entry. On the other hand in CAST with link clustering, any two entries of a particular cluster can be aggregated together provided that the new cluster numbers (outgoing) of those entries are same for all their next hop links. It can be seen that aggregation level of CAST is much higher than that of a normal aggregation technique. FIG. 41 shows the compression of multicast routing table as a function of the number of entries and the number of next hop links. Compression level in CAST increases with an increase of number of the entries. In contrast, the compression decreases with an increase of the number of next hop links. For 2500 entries and 8 next hop links, compression level of the CAST routing table reaches 0% line. Thus CAST in multicast achieves high aggregation power, if G>>2^{d+1} where G is the number of multicast group entries in a multicast routing table and d is the number of next hop links of the router.

3. Conclusion

Accordingly, CAST completely fulfills the main design objectives needed for a unicast and multicast lookup scheme in a cost effective way. In the same way it is applicable to all the routers on the path of a packet. CAST achieves high packet processing power together with a low memory usage and a low update time. Analytical and simulation results show that our technique performs better than other lookup techniques on the basis of design parameters: applicability, table lookup time, memory size, update time and multicast support. CAST is scalable for IPv6 and performs efficiently for high level of address aggregation. An interesting property of CAST is its scaling quality. It can be scaled according the need (e.g., switching speed) of the network. Lastly CAST compresses both unicast and multicast routing tables with a further level of aggregation of the entries.

Although the description above contains many specificities, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. A method for routing data packets in a network, comprising grouping routing-table entries into numbered clusters for lookup of a routing-table entry based on cluster number and destination address.

2. A method as recited in claim 1, further comprising assigning a cluster number to a data packet.

3. A method as recited in claim 2, further comprising routing said data packet based on a routing-table entry selected from a group of routing-table entries based on said cluster number and a destination address associated with said data packet.

4. A method as recited in claim 3, further comprising replacing said cluster number of said data packet with a new cluster number when said packet is routed.

5. A method as recited in claim 2, further comprising matching the cluster number associated with said data packet to a corresponding cluster number associated with said routing-table entries.

6. A method as recited in claim 5, further comprising searching routing-table entries associated with said cluster number using a destination address associated with said data packet as an index.

7. A method as recited in claim 6, further comprising routing said data packet using a routing-table entry corresponding to said destination address.

8. A method as recited in claim 7, further comprising replacing said cluster number of said data packet with a new cluster number when said packet is routed.

9. A method as recited in claim 1, further comprising assigning a Cluster Number (Incoming) and a Cluster Number (Outgoing) to each routing table entry.

10. A method as recited in claim 9, further comprising assigning a Cluster Number (Incoming) to said data packet.

11. A method as recited in claim 10, further comprising routing said data packet based on a routing-table entry selected from a group of routing-table entries corresponding based on said Cluster Number (Incoming) and a destination address associated with said data packet.

12. A method as recited in claim 11, further comprising replacing said Cluster Number (Incoming) of said data packet with the Cluster Number (Outgoing) associated with said selected routing-table entry when said data packet is routed.

13. A method as recited in claim 9, further comprising matching the Cluster Number (Incoming) associated with said data packet to a corresponding Cluster Number (Incoming) associated with said routing-table entries.

14. A method as recited in claim 13, further comprising searching routing-table entries associated with said Cluster Number (Incoming) using a destination address associated with said data packet as an index.

15. A method as recited in claim 14, further comprising routing said data packet using a routing-table entry corresponding to said destination address.

16. A method as recited in claim 15, further comprising replacing said Cluster Number (Incoming) of said data packet with the Cluster Number (Outgoing) associated with said corresponding routing-table entry when said data packet is routed.

17. A method for routing data packets in a network, comprising:
grouping routing-table entries into numbered clusters for lookup of a routing-table entry based on cluster number and destination address; and
routing a data packet based on a routing-table entry selected from a group of routing-table entries based on a cluster number and a destination address associated with said data packet.

18. A method as recited in claim 17, further comprising replacing said cluster number of said data packet with a new cluster number when said packet is routed.

19. A method as recited in claim 17, further comprising matching the cluster number associated with said data packet to a corresponding cluster number associated with said routing-table entries.

20. A method as recited in claim 19, further comprising searching routing-table entries associated with said cluster number using a destination address associated with said data packet as an index.

21. A method as recited in claim 20, further comprising routing said data packet using a routing-table entry corresponding to said destination address.

22. A method as recited in claim 21, further comprising replacing said cluster number of said data packet with a new cluster number when said packet is routed.

23. A method as recited in claim 17, further comprising assigning a Cluster Number (incoming) and a Cluster Number (Outgoing) to each routing table entry.

24. A method as recited in claim 23, further comprising assigning a Cluster Number (incoming) to said data packet.

25. A method as recited in claim 24, further comprising routing said data packet based on a routing-table entry selected from a group of routing-table entries corresponding based on said Cluster Number (Incoming) and a destination address associated with said data packet.

26. A method as recited in claim 25, further comprising replacing said Cluster Number (Incoming) of said data packet with the Cluster Number (Outgoing) associated with said selected routing-table entry when said data packet is routed.

27. A method as recited in claim 23, further comprising matching the Cluster Number (Incoming) associated with said data packet to a corresponding Cluster Number (Incoming) associated with said routing-table entries.

28. A method as recited in claim 27, further comprising searching routing-table entries associated with said Cluster Number (Incoming) using a destination address associated with said data packet as an index.

29. A method as recited in claim 28, further comprising routing said data packet using a routing-table entry corresponding to said destination address.

30. A method as recited in claim 29, further comprising replacing said Cluster Number (Incoming) of said data packet with the Cluster Number (Outgoing) associated with said corresponding routing-table entry when said data packet is routed.

31. A method for routing data packets in a network, comprising:
grouping routing-table entries into numbered clusters for lookup of a routing-table entry based on cluster number and destination address;
matching a cluster number associated with a data packet to a corresponding cluster number associated with said routing-table entries; and
routing said data packet based on a routing-table entry selected from a group of routing-table entries based on the cluster number and the destination address associated with said data packet.

32. A method as recited in claim 31, further comprising replacing said cluster number of said data packet with a new cluster number when said packet is routed.

33. A method as recited in claim 31, further comprising searching routing-table entries associated with said cluster number using a destination address associated with said data packet as an index.

34. A method for routing data packets in a network, comprising:
grouping routing-table entries into clusters;
assigning a Cluster Number (Incoming) and a Cluster Number (Outgoing) to each routing table entry;
assigning a Cluster Number (Incoming) to a data packet;
matching the Cluster Number (Incoming) associated with said data packet to a corresponding Cluster Number (Incoming) associated with said routing-table entries;
searching routing-table entries associated with said Cluster Number (Incoming) of said data packet using a destination address associated with said data packet as an index; and
routing said data packet based on a routing-table entry corresponding to the destination address associated with said data packet.

35. A method as recited in claim 34, further comprising replacing said Cluster Number (Incoming) of said data packet with the Cluster Number (Outgoing) associated with said selected routing-table entry when said data packet is routed.

36. A method for routing data packets in a network, comprising:
grouping routing-table entries into clusters;
assigning a Cluster Number (Incoming) and a Cluster Number (Outgoing) to each routing table entry;
assigning a Cluster Number (Incoming) to a data packet;
matching the Cluster Number (Incoming) associated with said data packet to a corresponding Cluster Number (Incoming) associated with said routing-table entries;
searching routing-table entries associated with said Cluster Number (Incoming) of said data packet using a destination address associated with said data packet as an index;
routing said data packet based on a routing-table entry corresponding to the destination address associated with said data packet; and
replacing said Cluster Number (Incoming) of said data packet with the Cluster Number (Outgoing) associated with said selected routing-table entry when said data packet is routed.
